(19) United States
(12) Patent Application Publication
(10) Pub. No.: US 2026/0363161 A1
(43) Pub. Date: Nov. 19, 2026

(54) A MODULAR DISPENSING SYSTEM, AN INTERCHANGEABLE METERING CASSETTE, A DISPENSING CASSETTE, ALL FOR USE IN AN AGRICULTURAL DISPENSING UNIT

(71) Applicant: BOON AG LIMITED, Springfield (NZ)

(72) Inventor: Andrew Murray GILLIES, Springfield (NZ)

(73) Assignee: BOON AG LIMITED, Springfield (NZ)

(21) Appl. No.: 19/126,027

(22) PCT Filed: Nov. 2, 2023
(86) PCT No.: PCT/IB2023/061091

§ 371 Date: Apr. 30, 2025

(30) Foreign Application Priority Data
Nov. 2, 2022 (AU) 2022903258
Feb. 8, 2023 (AU) 2023900302

(51) Int. Cl. A01C 7/12

(52) U.S. Cl. CPC A01C 7/121; A01C 7/124

(57) ABSTRACT

The present invention relates to a modular dispensing system, to an interchangeable metering cassette and to an interchangeable dispensing cassette all for use in an agricultural dispensing system unit. The modular dispensing system and various cassettes provide a number of possible dispensing options for the application of various seed types and fertilizer in small to large scale farming operations.

### FIELD

The present disclosure relates to a modular dispensing system, to an interchangeable metering cassette, a interchangeable dispensing cassette all for use in an agricultural dispensing system unit.

### BACKGROUND

Gravity seed drills are an agricultural machine used for seed dispersal and seed planting. Gravity seed drills traditionally include a hopper, a metering system and dispensing system. In use, the hopper is filled with seed. The seed then flows from a bottom opening of the hopper into the metering system. Seed is then metered through the metering system into the dispensing system and is dispersed onto or planted into the ground.

Many conventional gravity seed drills are limited and restricted by seed type and seed size that can be sowed. This is because the parameters of conventional gravity seed drills, such as the size of the bottom opening of the hopper, limit seed flow capability from the hopper into the metering system. This means the entire hopper must be changed or an entire new gravity seed drill must be selected to accommodate different seed types and different seed size. In addition, the metering system of conventional gravity seed drills is often exposed to the external environment. As a result, the metering system is particularly prone to weather or pest damage.

At present, if a farmer wishes to sow a mixture of crops involving different sized seeds, a number of different seed drills and systems are needed. A farmer, especially those on small to medium sized farms, does not always have access to several different seed drills and farmers will often rely on contractors to do the seed sowing for them. There can be delays in getting contractors engaged, in particular for crops that require precision planting, such as maise and fodder beet, and each day that is lost when seed has not been planted is a lost day of growth and production and potentially a loss in crop yield and carbon sequestration.

It is therefore an object of the disclosure to address at least some of the aforementioned disadvantages and problems and provide users with a convenient and practical solution, or at least provide the users with a useful choice.

### SUMMARY

In one aspect there is provided a modular dispensing system including an elongate housing, the elongate housing having spaced apart first and second elongate side walls, the side walls being spaced apart by an elongate top panel, the top panel of the housing being configured to be engageable with a hopper, the top panel being configured to allow the flow of matter within the hopper into the housing, when in use; the housing providing two or more spaced apart elongate channels that extend the length of the housing and that are configured to receive from a first end of the housing one or more interchangeable cassettes, at least one or more of the interchangeable cassettes being engageable with a drive unit located on the second end of the elongate housing, the modular dispensing system having a dispensing unit located at the bottom of the housing, the housing and one or more interchangeable cassettes being in fluid communication from the top panel of the elongate housing to the dispensing unit.

In one example, the housing of the modular dispensing system provides one or more pairs of ribs, one rib of each pair extending partially from an internal side wall of the housing facing the other rib extending partially from the opposing internal side wall, each rib extending along the length of the elongate channels, the ribs being configured to receive and bear corresponding flanges extending from the one or more interchangeable cassettes.

In one example, the one or more pairs of ribs taper upwardly towards the top panel of the housing at an angle selected from:
(a) up to about 5 degrees from the first end of the housing to the second end of the housing;
(b) up to about 4 degrees from the first end of the housing to the second end of the housing;
(c) up to about 3 degrees from the first end of the housing to the second end of the housing;
(d) up to about 2 degrees from the first end of the housing to the second end of the housing; and
(e) up to about 1 degree from the first end of the housing to the second end of the housing.

In one example, a top portion of each side panel flares outwardly to complement the profile of the top panel of the housing, the top panel, being configured to engage with a hopper positioned and nested thereon, when in use.

In one example, the one or more interchangeable cassettes is an interchangeable metering cassette.

In one example, the one or more interchangeable cassettes is an interchangeable dispensing cassette.

In one example, the one or more interchangeable cassettes is an interchangeable metering cassette and an interchangeable dispensing cassette.

In one example, the modular dispensing system is configured and adapted to be engaged with an agricultural seed drilling system.

In one example, the agricultural drilling system is a precision drilling system.

In one example, the agricultural drilling system is a gravity seed drill system.

In one example the modular dispensing system is positioned under and engaged with a hopper.

The present disclosure, in one aspect provides an interchangeable metering cassette for use in a modular dispensing system as defined above. The interchangeable metering cassette includes:
an elongate housing providing a plurality of spaced apart apertures configured to receive seed and/or fertilizer from a hopper, when in use,
wherein the elongate housing houses a metering system located beneath the apertures, the metering system including one or more metering rollers,
   wherein the one or more metering rollers are each mounted on an axle, wherein each axle substantially extends the length of the elongate housing;
wherein, in use, at least one axle is engageable with the drive unit on the modular dispensing system so as to rotate the one or more metering rollers, the rotation of the one or more metering rollers facilitating the controllable flow of seed and/or fertilizer through the metering system.

In one example, the interchangeable metering cassette includes:
a pair of metering rollers that extend substantially the length of the elongate housing,
wherein one face of a first metering roller is in surface contact with a second face of a second metering roller.

In one example, the interchangeable metering cassette includes a pair of metering rollers, the metering rollers being engageable to the drive unit on the modular dispensing system through a metering block located at one end of the interchangeable metering cassette, the metering block adapting a single drive shaft on the drive unit to a dual drive shaft mechanism which engages with a drive shaft for each metering roller.

In one example, the metering cassette includes:
a plurality of spaced apart metering rollers extending substantially the length of the elongate housing, and
wherein each metering roller includes a plurality of spaced apart indentations, wherein each indentation is configured and adapted in shape and size to receive seed, when in use.

In one aspect, an interchangeable dispensing cassette is provided for use in a modular dispensing system as defined above. The dispensing cassette includes:

an elongate housing having
a first row of first outlets which extend substantially the length of the cassette, and
a second row of second outlets adjacent the first row which extend substantially the length of the cassette,
a moveable paddle configured to, in use, facilitate directional flow and dispersion of seed and/or fertilizer through either:
   (a) the first row of first outlets, or
   (b) the second row of second outlets, or
   (c) both the first row of first outlets and the second row of second outlets.

In one aspect there is provided a kit comprising:
a modular dispensing system as defined above, and
one or more interchangeable cassettes as defined above.

In one example, the kit further includes one or more interchangeable dispensing cassettes as defined above.

In one example, the kit further includes one or more hoppers.

In one aspect, an agricultural dispensing system is provided. The agricultural hopper system includes:
a hopper configured to house seed and/or fertilizer, wherein the hopper includes a top opening and a bottom opening,
an interchangeable metering cassette as defined above, wherein the interchangeable cassette is proximate to and substantially extends the length of the bottom opening of the hopper.

In one example, the agricultural hopper system further includes:
a dispensing cassette proximate the bottom opening of the hopper, wherein, in use, seed and/or fertilizer flow through the bottom opening of the hopper into the dispensing cassette;
wherein the dispensing cassette comprises:
a first row of outlets which extend substantially the length of the bottom opening of the hopper, when in use.

In one aspect, an agricultural dispensing apparatus for seed and/or fertilizer dispersal is provided. The agricultural dispensing apparatus includes:
a hopper configured to house seed and/or fertilizer, wherein the hopper includes a top opening and a bottom opening;
a dispensing cassette proximate the bottom opening of the hopper, wherein, in use, seed and/or fertilizer flow through the bottom opening of the hopper into the dispensing cassette,
wherein the dispensing cassette includes:
   a first row of first outlets which extend substantially the length of the bottom opening of the hopper, when in use; and
   a second row of second outlets adjacent the first row which extend substantially the length of the bottom opening of the hopper, when in use;
   a moveable paddle configured to, in use, facilitate directional flow and dispersion of seed and/or fertilizer through either:
      (a) the first row of first outlets, or
      (b) the second row of second outlets, or
      (c) both the first row of first outlets and the second row of second outlets.

In one example, the paddle movement is controllable through an elongate drive shaft that upon rotation rotates the paddle from between the first row of outlets to the second row of outlets, and wherein the paddle is configured to shut off access to the first row of outlets or shut off access to the second row of outlets. In one example, the paddle may be positioned in a plurality of intermediate positions which, in use, facilitates proportional controllable dispersion of any seed and/or fertilizer through the first row of outlets and/or the second row of outlets.

In one aspect, an agricultural dispensing system is provided. The agricultural dispensing system includes:
a hopper configured to house seed and/or fertilizer, wherein the hopper includes a top opening and a bottom opening;
an interchangeable metering cassette as defined above, wherein the interchangeable cassette is proximate to and substantially extends the length of the bottom opening of the hopper; and
a dispensing system as defined above, wherein the dispensing system is positioned beneath the interchangeable cassette.

### BRIEF DESCRIPTION OF THE FIGURES

The modular dispensing system, the interchangeable metering cassette, the interchangeable dispensing cassette, all for use in an agricultural dispensing unit are now described, by way of non-limiting examples, with reference to the accompanying figures, in which:

FIG. 1 shows a sectioned front left side perspective view of an interchangeable metering cassette including a pair of metering rollers.

FIG. 2 shows a cross-section left side perspective view of the interchangeable metering cassette including a pair of metering rollers in relation to a hopper.

FIG. 3 shows an enlarged cross-section left side perspective view of the interchangeable metering cassette including a pair of metering rollers in relation to the hopper.

FIG. 4 shows a sectioned left side view of the interchangeable metering cassette including a pair of metering rollers.

FIG. 5 shows a sectioned top perspective view of a plurality of paired metering rollers extending the length of the interchangeable metering cassette.

FIG. 6 shows a sectioned rear left perspective view of the interchangeable metering cassette including a pair of metering rollers and an elongate lock out slide.

FIG. 7 shows a sectioned front left perspective schematic view of the interchangeable metering cassette including a pair of metering rollers with a friction-reducing layer, which also doubles as a locating profile when engaged with a complimentary profile on the bottom of the hopper.

FIG. 8 shows a sectioned front left perspective view of an interchangeable metering cassette including one or more metering rollers, each metering roller having a plurality of spaced apart indentations.

FIG. 9 shows a sectioned front view of an interchangeable metering cassette including one or more metering rollers, each metering roller having a plurality of spaced apart indentations.

FIG. 10 shows a sectioned front view of an interchangeable metering cassette having a metering system including one or more metering rollers, each metering roller having a plurality of spaced apart indentations and an elongate lock out slide.

FIG. 11 shows a sectioned top perspective view of an interchangeable cassette including a plurality of spaced apart apertures substantially extending the length of an elongate housing.

FIG. 12 shows a sectioned top perspective view of an interchangeable cassette including a plurality of spaced apart metering rollers extending substantially the length of the elongate housing, each metering roller including a plurality of spaced apart indentations.

FIG. 13 shows an enlarged cross-section right side perspective view of an interchangeable cassette including a plurality of precision metering rollers, each metering roller having a plurality of spaced apart indentations.

FIG. 14 shows a left side schematic view of the internal workings of an interchangeable dispensing cassette positioned above dispensing channels of the dispensing unit.

FIG. 15 shows a left perspective schematic view of a portion of the length of a portion of the dispensing system including an interchangeable dispensing cassette positioned above dispensing channels of the dispensing units.

FIG. 16 shows a sectioned rear left perspective of a modular dispensing system having an interchangeable metering cassette including a pair of metering rollers positioned above an interchangeable dispensing cassette, which is positioned above dispensing channels of the dispensing unit.

FIG. 17 shows a sectioned left view of a modular dispensing system as shown in FIG. 16 engaged with a hopper.

FIG. 18 shows a perspective view of the modular dispensing system as shown in FIG. 16 engaged with a hopper.

FIG. 19 shows an exploded front perspective schematic view of the modular dispensing system and the components of the system relative to a hopper, the components of the modular dispensing system including an interchangeable metering cassette and an interchangeable dispensing cassette.

FIG. 20 shows an enlarged schematic view of the configuration of a lock out slide in relation to the hopper and the components of the interchangeable metering cassette and the interchangeable dispensing cassette.

FIG. 21(a) to 21(g) show examples of differing configurations of the interchangeable metering cassette. For example, FIG. 21(a) shows a dual roller configuration suitable for small to high rate seed, FIG. 21(b) shows a dual roller configuration with the rollers having medium sized indentations to assist with the metering and control of seed flow; FIG. 21(c) shows a dual roller configuration with the rollers having larger sized indentations to assist with the metering and control of seed flow; FIG. 21(d) shows a dual roller configuration suitable for small seed, where the lead into the rollers is angled to funnel the seed towards the centre of the rollers; FIG. 21(e) shows a single roller with a resilient or biased lever in place of the second roller to offer an alternative seed feed option into the interchangeable metering cassette and past the roller; FIG. 21(f) shows a single roller having large sized indentations to assist with the metering and control of seed flow; 21(g) shows a single roller having segments suitable for holding liquid, where a liquid seed mix or a liquid fertiliser flow may be controlled through the interchangeable metering cassette and into an interchangeable dispenser cassette or dispensing unit.

FIG. 22 shows a schematic view of the drive unit to drive one or more shafts within the interchangeable cassettes within the modular dispensing system.

FIG. 23 shows a schematic view of an agitator in the proximity of the small seed dual roller configuration shown above in FIG. 21(d).

FIG. 24 shows a schematic view of an agitator located within the modular dispensing system above an interchangeable measuring cassette housing a dual roller configuration as shown in FIG. 21(a).

FIG. 25 shows an interchangeable precision metering cassette.

FIG. 26 shows a photograph of a modular dispensing system positioned underneath a hopper.

FIG. 27 shows a photograph of an end on view from a first end of the modular dispensing system.

FIG. 28 shows a photograph of another end on view from a first end of the modular dispensing system through the system to the drive system on the second end.

FIG. 29 shows a close up photograph taken from the first end of the modular dispensing system right through the system to the drive system on the second end and shows rails 206 tapering upwardly about 3 degrees from the first end to the second end of the modular dispensing system.

FIG. 30 shows a photograph of an end on view from a first end of the modular dispensing system showing an interchangeable cassette having dual rollers in position.

FIG. 31 shows a photograph of an end on view from a first end of the modular dispensing system showing a lock out slide in position beneath the interchangeable cassette.

FIG. 32 shows a photograph of an end on view from a first end of the modular dispensing system showing an interchangeable metering cassette in position, a lock out slide or sponge scrapper in position beneath the interchangeable measuring cassette and an interchangeable dispensing cassette 221 in position under the lock out slide.

FIG. 33 shows a close up photograph of the space between a first end of the modular dispensing system, showing the bottom of the interchangeable measuring cassette having dual sponge rollers, and an interchangeable dispensing cassette.

FIG. 34 shows a photograph taken of a second end of the modular dispensing system showing a drive unit comprising a chain and a sprocket that drives a centrally located drive shaft within the one or more cassettes within the modular dispensing system.

FIG. 35 (a) shows a drive shaft metering block that is optionally located at the end of an interchangeable cassette and FIG. 35(b) shows an exploded view of the gearing in the metering block converting a single drive shaft to a dual drive shaft mechanism that engages with the dual drive shafts within the interchangeable metering cassette.

FIG. 36 shows a perspective schematic view of a calibration tray for use in a modular dispensing system.

FIG. 37 shows a schematic view of an agricultural dispensing unit comprising two hoppers, and a modular dispensing system positioned beneath each hopper.

In reviewing the figures, and especially the schematics, the proportions shown in the figures, and the specific position of elements is not intended to be limiting with respect to the structures disclosed or the scope of the claims appended hereto, but rather are intended to be instructive of a generic concept.

### DETAILED DESCRIPTION

### Definitions

As used in this specification, the terms “comprises”, “comprising”, “includes” and “including” are to be construed as being inclusive and open ended rather than exclusive.

Specifically, when used in this specification, including the claims, the terms “comprises”, “comprising”, “includes” and “including” and variations thereof mean that the specified features, steps or components are included. The terms are not to be interpreted to exclude the presence of other features, steps or components.

The term “about” as used herein in connection with a referenced numeric indication means the referenced numeric indication plus or minus 10% of that referenced numeric indication. For example, the language “about 100 mm” covers the range of 90 mm to 110 mm.

The term “approximately” as used herein, means close or near to, near in position, close together, essentially.

The term “agricultural hopper system” as used herein means a device or apparatus used in agriculture which is suitable for housing and releasing, dispersing and/or dispensing agricultural matter such as, without limitation, seed and/or fertilizer. The agricultural hopper system may include a hopper and a metering system in which the metering system is capable of metering agricultural matter through the metering system for release, dispersal and/or dispense.

The term “fertilizer” as used herein means any organic, inorganic, natural or synthetic material which supplies one or more chemical elements required for plant growth. The term “fertilizer” includes, without limitation, liquid fertilizer and organic fertilizer. Non-limiting examples of organic fertilizer include manure, slurry fertilizer, worm castings, peat, seaweed fertilizer, guano, compost, bloodmeal, bone meal and the like. Non-limiting examples of liquid fertilizer include potassium chloride liquid fertilizer, potassium nitrate liquid fertilizer, potassium magnesium sulfate liquid fertilizer, potassium sulfate liquid fertilizer, urea liquid fertilizer, calcium ammonium nitrate liquid fertilizer, and the like.

The term “hopper” as used herein means a receptacle for housing material, product or agricultural matter such as seed and/or fertilizer. The receptable can be adapted and configured in a variety of shapes and sizes such that it is suitable for use in an agricultural machine, such as, without limitation, a gravity seed drill or a gravity seed hopper system. For example, the hopper may include a substantially cone-shape or a funnel shape. The term “hopper” may include one hopper or a plurality of hoppers, such as, without limitation, at least two, at least three, at least four or at least five hoppers.

The terms “interchangeable metering cassette” or “interchangeable dispensing cassette” as used herein means a cassette as described herein capable of being removed and/or interchanged from an agricultural hopper system. For example, the interchangeable metering or dispensing cassette may be configured and adapted in shape and size such that an elongate housing of the interchangeable cassette is attachable beneath a hopper of the agricultural hopper system, when in use. This allows the interchangeable measuring or dispensing cassette to be removed, replaced or interchanged, or retrofitted to a variety of different agricultural hopper systems, or the like. The interchangeable metering or dispensing cassette is configured to control the flow of seed or fertiliser from a hopper through the modular dispensing system. The interchangeable metering or dispensing cassette may have several possible configurations to control the flow of seed or fertiliser depending on the nature of the seed or fertiliser and the desired speed of release of the seed or fertiliser through the modular dispensing system.

The term “seed” as used herein means a singular seed or a plurality of seeds. The term encompasses any seed capable or suitable for use in precision planting or capable or suitable for use in a gravity seed hopper system or a gravity seed drill. Non-limiting examples of suitable seed types include seed such as grass, wheat, barley, rye, rapeseed, oats, peas, beans, soybeans, alfalfa, kale, carrot, radish, hemp, swede, maize, fodder beet, and the like.

The term “soft” as used herein means capable of substantial deformation when in contact with seed being dispensed, such that the seed is not damaged.

The term “substantially” as used herein, means for the most part, or mostly, or essentially, or to a great or significant extent.

### Interchangeable Cassette

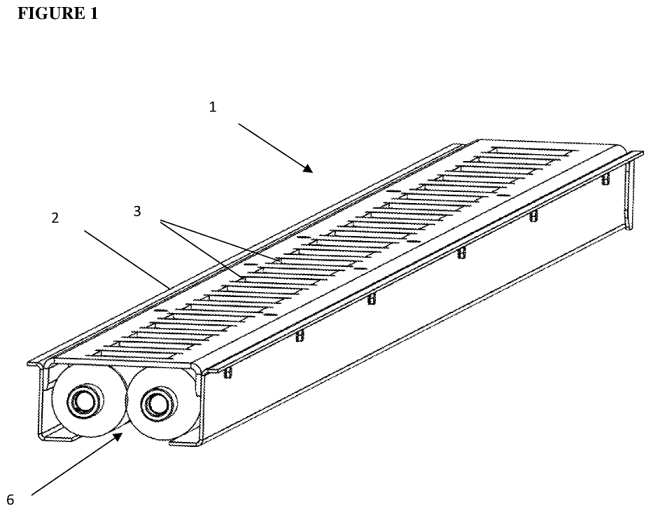

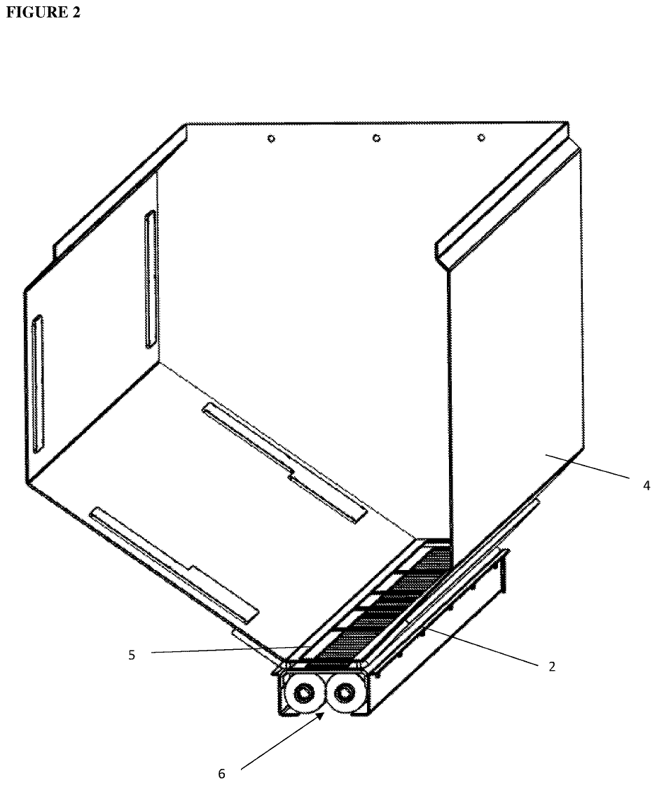

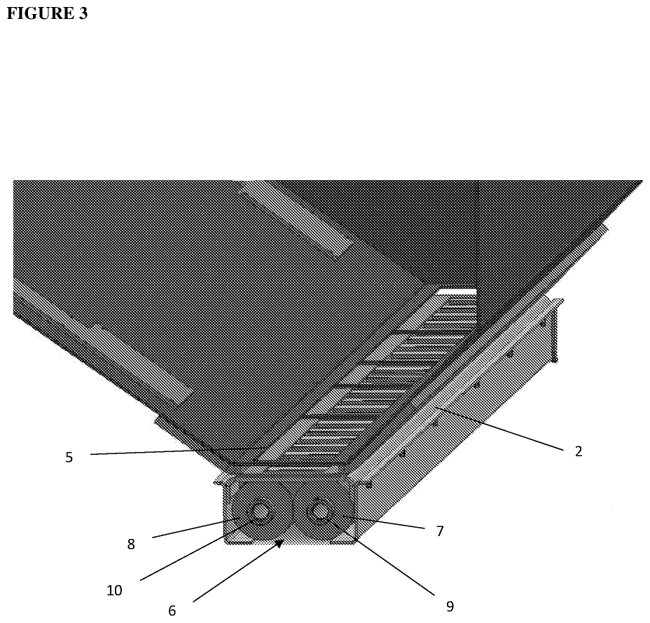

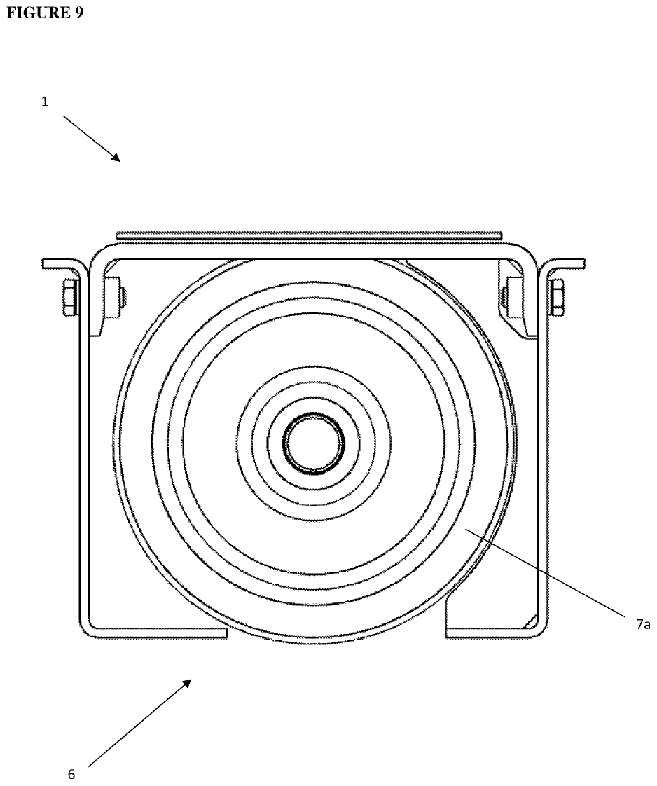

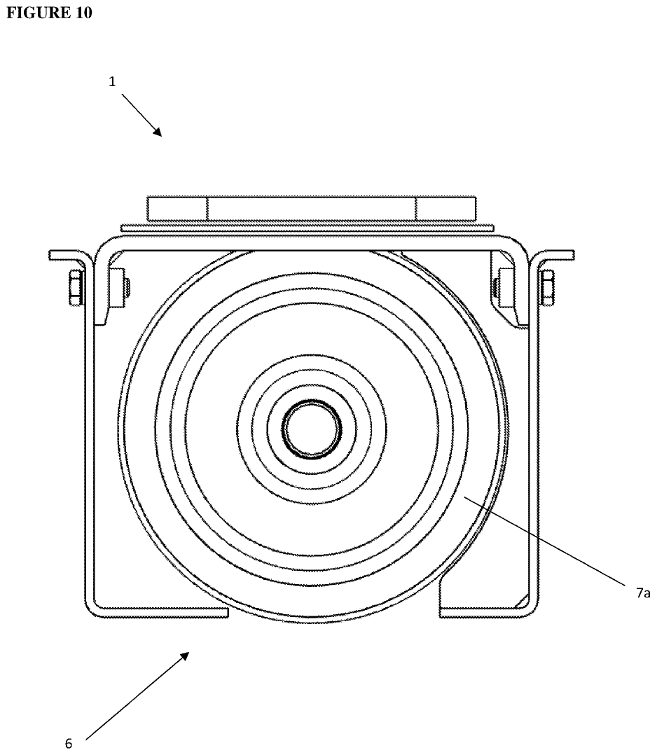

With reference to FIGS. 1 to 13, an interchangeable metering cassette 1 suitable for use in an agricultural hopper system is shown. In one example, the interchangeable metering cassette is suitable for use in a gravity seed hopper system. For example, the interchangeable metering cassette may be attachable to and/or interchangeable with the agricultural hopper system at a position substantially beneath a hopper. The interchangeable metering cassette 1 includes an elongate housing 2 providing a plurality of spaced apart apertures 3 configured to receive seed and/or fertilizer from a hopper 4, when in use. In the example shown in FIGS. 2 and 3, the elongate housing 2 substantially extends the length of a bottom opening 5 of the hopper 4, when in use. It is to be appreciated that the length of the metering cassette can be adapted and configured to be a variety of lengths such that it is suitable for use with a variety of different sized and shaped hoppers. For example, the metering cassette may be configured and adapted to be a variety of different shapes and sizes such that interchangeable cassette may be interchanged and retrofitted to a variety of different sized and shaped agricultural hopper systems, and/or the like. In one example, the interchangeable metering cassette is configured to be attachable to the agricultural hopper system. In one example, the interchangeable metering cassette is configured to be attachable to the agricultural hopper system at a position substantially beneath the hopper. In one example, the interchangeable metering cassette is configured to be interchangeable with the agricultural hopper system. It is to be appreciated that the interchangeable metering cassette may be configured to be attachable to and/or interchangeable with the agricultural hopper system in a variety of different suitable ways, and that the examples shown and described herein are by way of non-limiting example only. For example, and without limitation, the interchangeable metering cassette may be configured to be slidably attachable to the agricultural hopper system. In one non-limiting example, one or more lengthwise edges of the interchangeable metering cassette may include one or more protrusions or flanges configured in shape and size to substantially complement one or more complementary slots on the agricultural hopper system such that, in use, the interchangeable metering cassette is slidably attachable to the agricultural hopper system. In one example, each lengthwise edge of the interchangeable metering cassette includes one or more protrusions or flanges configured in shape and size to substantially complement one or more complementary slots on the agricultural hopper system. In one example, the one or more protrusions or flanges on the elongate housing extend substantially the length of the interchangeable metering cassette.

The interchangeable metering cassette can be constructed of any suitable material. In one example, the elongate housing is constructed of one or more industrially robust materials, such as, without limitation, steel, mild steel, stainless steel, carbon fibre, plastic and the like.

In one example, the apertures 3 along the top of the interchangeable metering cassette are approximately evenly spaced apart. In one example, the apertures 3 substantially extend the length of the interchangeable metering cassette 2, although it is to be appreciated that there may be some situations or configurations where the apertures do not extend the length of the housing. In use, flow of seed and/or fertilizer from the hopper 4 into the interchangeable metering cassette 2 may be limited by the number of apertures, and/or aperture size. This is advantageous because the plurality of apertures by way of number and size provide a mechanism for controlling seed and/or fertilizer flow from the hopper into the interchangeable cassette. For example, the aperture size and the interchangeability of the interchangeable cassette allow a user to control seed flow (such as by way of seed-type, seed-size, and/or seed flow rate) from the hopper and into the interchangeable cassette without needing to replace the entire hopper.

In one example, aperture size is selected depending on seed type and/or fertilizer type, when in use. In one example, the apertures are a predetermined size. In one example, aperture size is between about 5 mm to about 15 mm in width. In one example, aperture size is between about 15 mm to about 100 mm in width. In one example, aperture size is configured to receive seed such as wheat, barley, rye, rapeseed, oats, peas, soybeans, alfalfa, hemp, swede, maize, fodder beet, and the like. For example, aperture size that is configured to be between about 15 mm to about 100 mm in width is suitable for receiving seed such as, without limitation, grass, barley, pea, oat and/or the like, and aperture size that is configured to be between about 5 mm to about 30 mm in width is suitable for receiving seed such as, without limitation, fodder beet, swede, kale, rape, hemp and/or the like. In one example, aperture size is configured to receive fertilizer such as organic or liquid fertilizer. Non-limiting examples of organic fertilizer include manure, slurry fertilizer, worm castings, peat, seaweed fertilizer, guano, compost, bloodmeal, bone meal and the like. Non-limiting examples of liquid fertilizer include potassium chloride liquid fertilizer, potassium nitrate liquid fertilizer, potassium magnesium sulfate liquid fertilizer, potassium sulfate liquid fertilizer, urea liquid fertilizer, calcium ammonium nitrate liquid fertilizer, and the like. It is to be appreciated that aperture size can be shaped and configured in a variety of ways to receive a variety of singular seed types, a plurality of seed types, a variety of singular fertilizer types, or a plurality of fertilizer types and the configurations illustrated are by way of example only and are not intended to be limiting on the disclosure.

The elongate housing 2 houses an interchangeable metering cassette 6 located beneath the apertures 3. In one example, the interchangeable metering cassette includes one or more metering rollers and a drive shaft 9, 10, as shown in FIG. 3.

In one example, the one or more metering rollers are each mounted on an drive shaft or axle 9, 10 that extends substantially the length of the elongate housing 2 of the interchangeable metering cassette. In use, at least one drive shaft or axle is engageable with the driving unit so as to rotate the one or more metering rollers, the rotation of the one or more metering rollers facilitates the controllable flow of seed and/or fertilizer through the interchangeable metering cassette. In one example, the driving unit is a single driving unit, wherein the single driving unit is engageable with the at least one drive shaft or axle so as to rotate the one or more metering rollers, when in use.

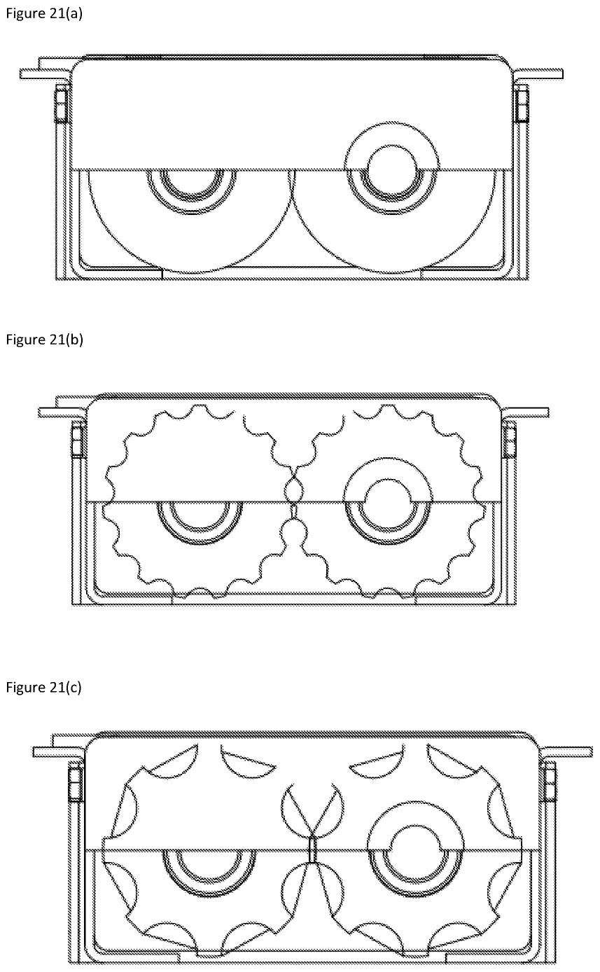

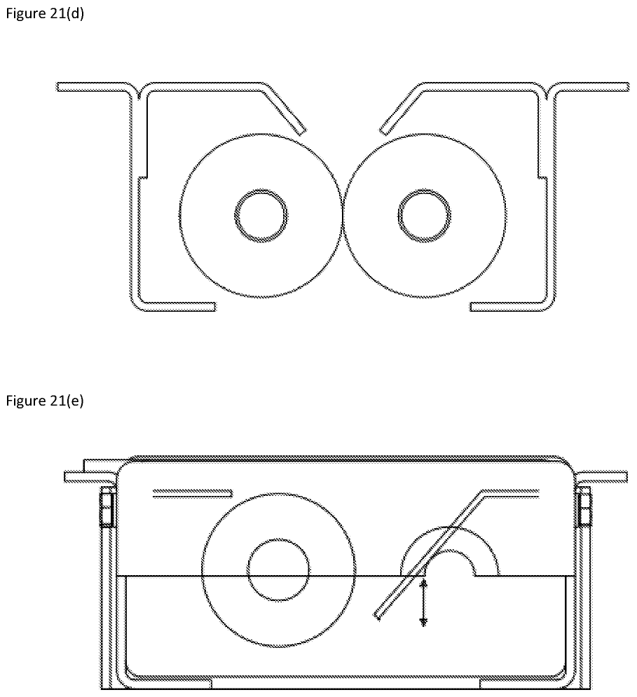

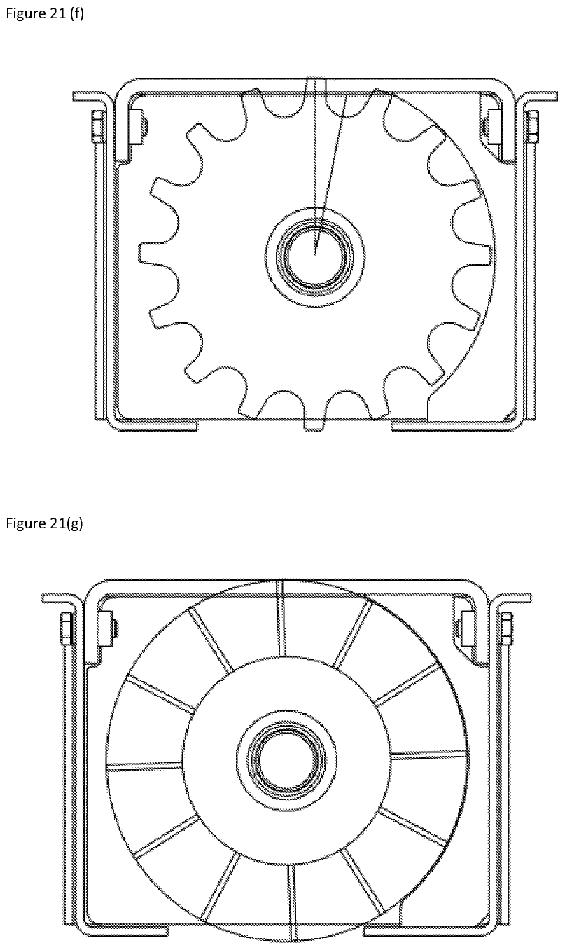

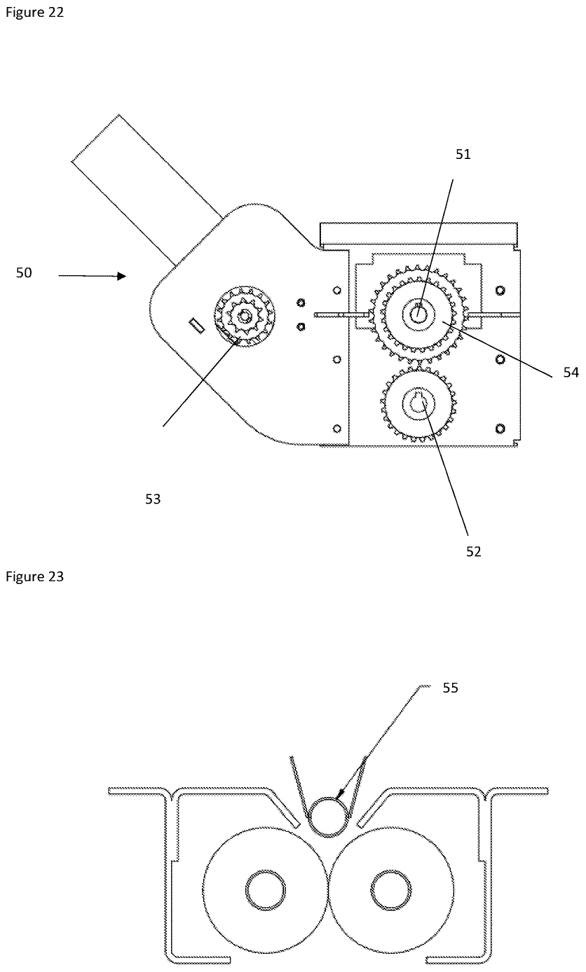

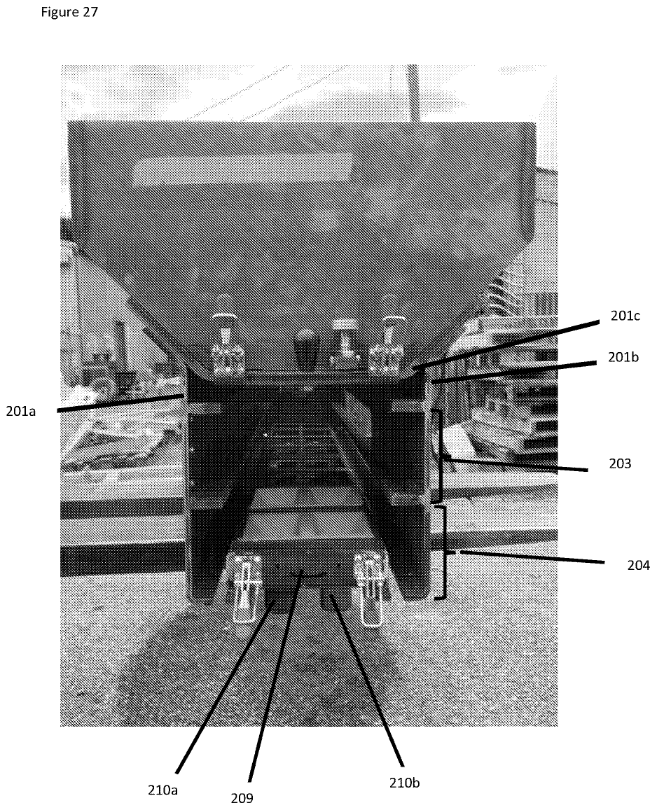

In one example, each drive shaft or axle includes a sprocket at a first end. In use, the sprocket on at least one drive shaft or axle is engageable with a complimentary sprocket on the drive unit (not shown) to facilitate rotation of at least one axle and the one or more metering rollers. In one example, the sprocket on a first axle is engageable with both the sprocket on a second axle and the complimentary sprocket on the driving means, when in use. In this example, rotation of the drive unit facilitates rotation of the first drive shaft or axle, which facilitates rotation of the second drive shaft or axle, when in use. In one example, each sprocket on each drive shaft/axle is engageable with the complimentary sprocket of the driving means to facilitate rotation of each axle and each metering roller, when in use. It is to be appreciated that the drive unit can engage with the one or more drive shafts/axles in a variety of ways to facilitate rotation of the one or more metering rollers, when in use, and that the examples shown and described herein are non-limiting examples. An example of a drive system 50 is shown in FIG. 22. This system shows schematically how it is possible to engage one or more drive shafts 51 and 52 in a vertical disposition relative to each other while having a single drive chain (not shown) connected to drive sprocket 53 that drives sprocket 54 on drive shaft 51. With further reference to FIGS. 23 and 24, having the ability to drive one or drive shafts in a vertical disposition is helpful in the event an agitator 55 is required to be driven to mix up or free up the seed/fertiliser before the seed or fertiliser enters into an interchangeable metering cassette. It is also envisaged that where two interchangeable metering cassettes are used, one on top of the other that the drive shafts of the two vertically disposed interchangeable metering cassettes can be driven utilising a single drive system 50. The location of the drive shaft is preferably designed to be positioned proximate the bottom of a regular sized interchangeable metering cassette that accommodates a single channel (eg channel 203 in FIG. 27) in the modular dispensing system. This location of the drive shaft provides the benefit of being able to also accommodate a larger single roller precision cassette (eg as shown in FIG. 21(f)) and the drive shaft is now centrally located for the larger cassette.

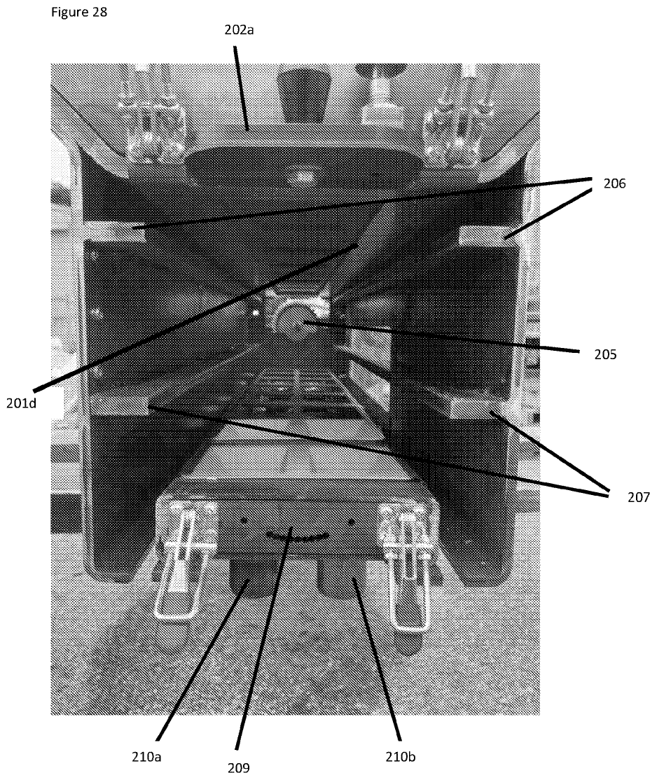

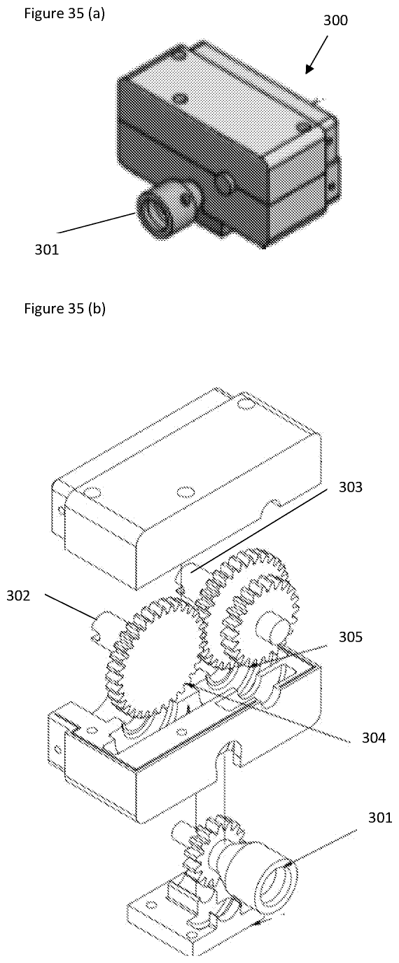

With reference to FIG. 35(a) a drive shaft metering block 300 is shown. This metering block is optionally located at the end of an interchangeable cassette having dual drive shafts and is designed to adapt a single drive shaft 301 to a dual drive shaft mechanism. FIG. 35(b) shows an exploded view of the gearing in the metering block 300 converting a single drive shaft 301 to a dual drive shaft 302 and 303 that is engageable with the dual drive shafts within the interchangeable metering cassette. It is to be appreciated that various gearing or sprocket configurations and sizing of left 304 and right 305 gears/sprockets may be adopted within the metering block depending on the desired drive requirements for the metering rollers and the size of the metering rollers within the interchangeable cassette. The drive shaft 301 engages with the external drive unit 205 shown in FIG. 28.

In one example, the interchangeable metering cassette includes two or more metering rollers that extend substantially the length of the elongate housing. In the example shown in FIG. 1, the interchangeable metering cassette 6 includes a pair of metering rollers 7, 8 that extend substantially the length of the elongate housing 2. One face of a first metering roller 7 is in surface contact with a second face of a second metering roller 8. In use, at least one axle is engageable with the drive unit so as to rotate the metering rollers. In use, the rotation of the metering rollers facilitates the controllable flow of seed and/or fertilizer through the metering system 6. In one example, each axle includes a sprocket at a first end (not shown). In one example, each sprocket on each axle is engageable with a complimentary sprocket of the driving means to facilitate rotation of each axle and each metering roller, when in use. In one example, each metering roller may be configured to rotate in an opposing direction to facilitate flow of seed and/or fertilizer between the metering rollers, when in use. The rate of rotation of each axle 9, 10 is controlled by the rate of rotation of the drive unit, when in use. In one example, the rate of rotation of the drive unit is adjustable, when in use. In one example, the rate of rotation of the driving means is controllable by electronics (not shown). In one example, the speed of rotation of each axle is substantially proportional to the desired flow rate of seed and/or fertilizer. For example, the rate of seed and/or fertilizer flow through the interchangeable metering cassette may be slowed down by reducing the speed of rotation of each metering roller, when in use. In one example, direction of seed and/or fertilizer flow can be controlled by disproportionally adjusting the rate or speed of each metering roller, when in use.

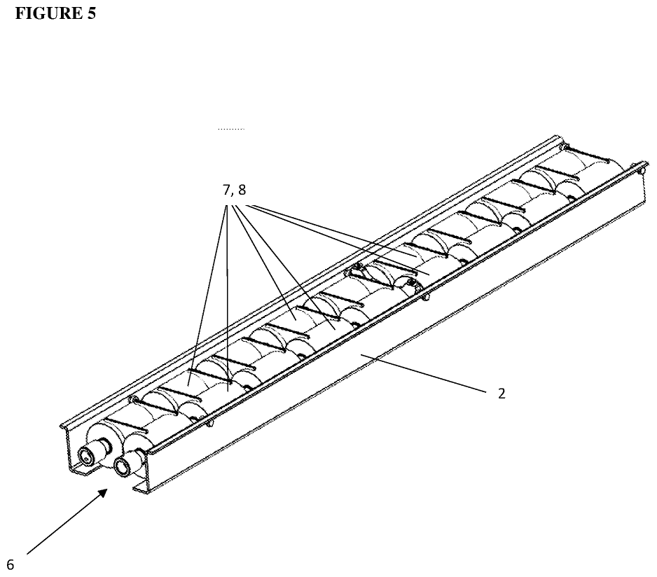

In the example shown in FIG. 5, the interchangeable metering cassette 6 includes a plurality of paired metering rollers 10 that together substantially extend the length of the elongate housing 2. One face of a first metering roller of each pair is in surface contact with a second face of a second metering roller of the pair. In one example, the plurality of paired metering rollers are approximately evenly spaced substantially across the length of the elongate housing. In one example, the plurality of paired metering rollers includes at least 2 pairs of metering rollers. In one example, the plurality of paired metering includes at least 7, at least 10, at least 15, at least 20 or at least 25 pairs of metering rollers. It is to be appreciated that the plurality of paired metering rollers can include any number of paired metering rollers and the configuration illustrated is just one example and is not intended to be limiting on the disclosure.

In one example, the interchangeable metering cassette three or more, four or more, or five or more metering rollers that substantially extend the length of the elongate housing (not shown). It is to be appreciated that the interchangeable metering cassette can include any number of metering rollers and that any such plurality of metering rollers can be arranged in a variety of ways to facilitate seed and/or fertilizer flow through the metering system, and the examples described herein are just possible examples of configurations and are not intended to be limiting on the disclosure.

In one example it is to be appreciated that more than one interchangeable metering cassette may be stacked one on top of another to provide an even more controlled passage of seed or fertiliser from a hopper through the interchangeable metering cassettes.

In one example, each metering roller includes an outer casing fabricated from a soft and resilient material. Non-limiting examples of soft and resilient materials include foam, rubber, nylon, and the like. In one example, each metering roller includes an outer casing fabricated from sponge foam. The soft and resilient or sponge foam material may allow a variety of different sized and shaped seed type and/or different fertilizer type to be metered through the metering system. In use, soft and resilient outer surfaces of each metering roller can compress to accommodate seed of varying shapes and sizes and/or different fertilizer type. Additionally, this protects the seed from damage such as cracking.

In one example, each metering roller of the pair of metering rollers is independently interchangeable. In one example, each outer casing of each metering roller is independently interchangeable. The size and configuration of each metering roller and/or each outer casing may be selected and interchanged depending on the seed type and/or fertilizer type to be metered. This is advantageous because a user can interchange and select each metering roller, and/or each outer casing, depending on the seed type and/or fertilizer type to be metered, without needing to interchange or replace the entire interchangeable cassette. It is to be appreciated that a variety of different sizes and configurations of metering rollers can be used in the metering system, and the size and configuration of the metering rollers may be selected and interchanged depending on the seed type and/or fertilizer type to be metered, when in use. Several examples of differing configurations of interchangeable metering cassettes are shown in FIG. 21(a) to 21(g).

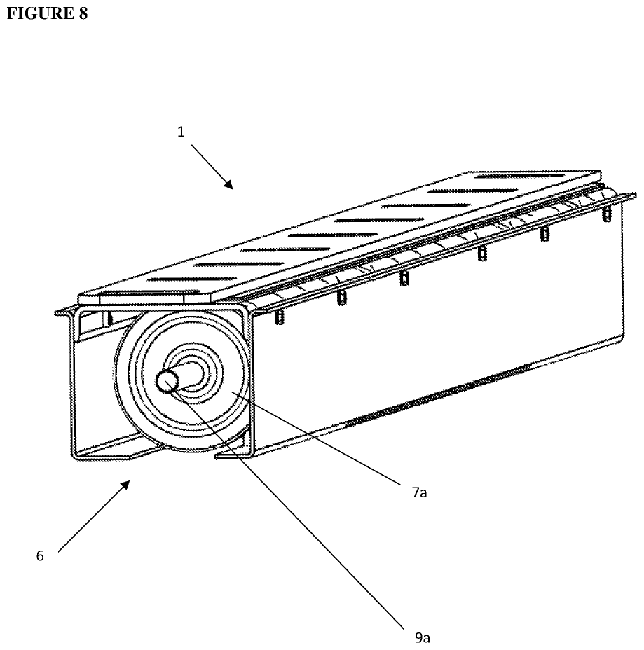

In an alternative example, the interchangeable metering cassette includes one or more metering rollers mounted on a single axle, the single axle substantially extending the length of the interchangeable metering cassette. In one example, the one or more metering rollers extend substantially the length of the elongate housing. In one example, the interchangeable metering cassette includes a plurality of metering rollers, each metering roller being mounted on the single axle, and the plurality of metering rollers together extending substantially the length of the interchangeable metering cassette. In the example shown in FIGS. 8 to 13, the interchangeable metering cassette 6 includes one or more metering rollers 7a, wherein the one or more metering rollers 7a includes a plurality of spaced apart indentations 28. Each spaced apart indentation 28 is adapted and configured in shape and size to receive seed, when in use. In use, the one or more metering rollers 7a including a plurality of spaced apart indentations 28 are each mounted on an axle 9a, wherein the axle 9a substantially extends the length of the interchangeable metering cassette 6. In use, the axle is engageable with drive unit so as to rotate the one or more metering rollers 7a. In use, the rotation of the one or more metering rollers facilitates controllable flow of seed through the interchangeable metering cassette. In one example, the axle includes a sprocket at a first end. In use, the sprocket on the axle is engageable with a complimentary sprocket on the drive unit to facilitate rotation of the axle and the one or more metering rollers (not shown). In one example, the rate of rotation of the driving means is adjustable, when in use. In one example, the adjustable rate of rotation of the drive unit is controllable by electronics (not shown). In one example, the speed of rotation of the one or more metering rollers is substantially proportional to the desired flow rate of seeds. For example, the rate of seed flow through the interchangeable metering cassette may be slowed down by reducing the speed of rotation of the one or more metering rollers, when in use.

In one example, the one or more metering rollers includes between 1 to 20 indentations, between 2 to 15, between 3 to 10, between 4 to 8, or between 6 to 8 indentations. It is to be appreciated that any number of indentations can be provided on the one or more metering rollers and that the examples illustrated and described herein are by way of example only and are not intended to be limiting on the disclosure. In one example, the configuration (such as the size, shape and depth) of each indentation is a predetermined size, selected for seed type. For example, the indentations may be a predetermined size, selected for a specific seed type. Non-limiting examples of seed type include fodder beet, maize, hemp, swede, or the like. In one example, each indentation on each metering roller is substantially the same size. In one example, each indentation is configured in shape and size to receive a single seed, when in use. In one example, the one or more metering rollers is interchangeable. The size and configuration of each metering roller may be selected and interchanged depending on the seed type to be metered.

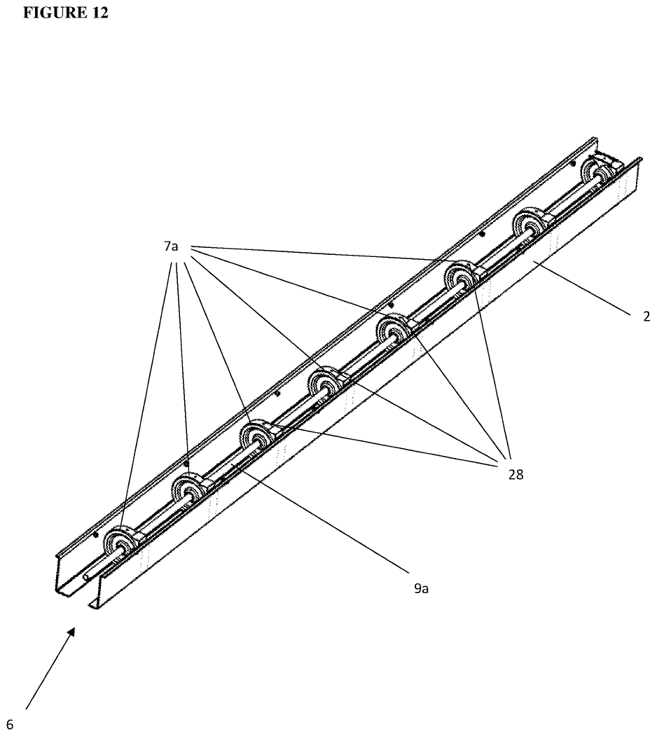

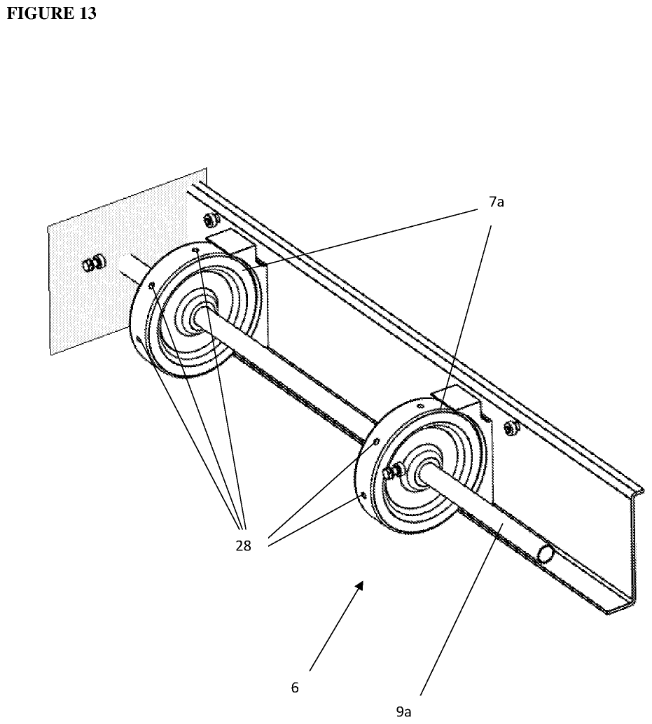

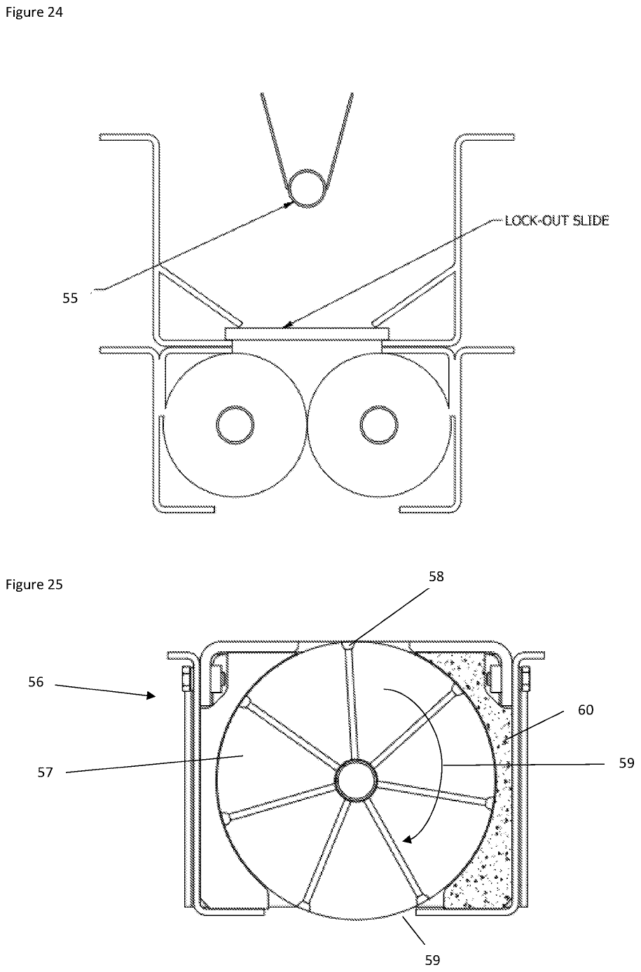

In the example shown in FIGS. 12 to 13, the interchangeable metering cassette 6 includes a plurality of spaced apart metering rollers 7a extending substantially the length of the interchangeable metering cassette 2. Each metering roller of the plurality of spaced apart metering rollers includes a plurality of spaced apart indentations 28, and each indentation is configured in shape and size to receive seed, when in use. In one example, each metering roller of the plurality of metering rollers is independently interchangeable. In one example, the interchangeable metering cassette includes at least 2, at least 3, at least 4, at least 5, at least 6, at least 7, at least 8, at least 9, or at least 10 metering rollers extending substantially the length of the interchangeable metering cassette. It is to be appreciated that the plurality of metering rollers can include any number of metering rollers and that the configuration illustrated is just one example and is not intended to be limiting on the disclosure. It is also to be appreciated that the interchangeable precision cassette may be designed to have only 6 to 8 apertures so that the seed is spaced further apart in the ground, depending on the seed being planted. For example, maize and fodder beet swede seeds will be spaced about 300-500 mm apart. It is to be appreciated that the hopper may also be adapted and configured to have separated compartments for every aperture so a farmer may choose to fill every second or third or fourth compartment in the hopper to selectively ensure separated planting and sufficient space between the planted seeds. Another particular example of an interchangeable metering cassette is shown in FIG. 25, and this is another example of a precision planting metering cassette 56. FIG. 25 is a cross sectional view of a precision planting disc 57 into which a seed (not shown) of a selected size falls into an indentation 58 and the seed is rotated in the direction of travel shown by arrow 59 past a plastics or foam seed retaining means 60 to the opening at the bottom of the cassette 61 through which the seed drops. The number of different configurations for the interchangeable cassettes and also for the hopper provides a multitude of seed sowing, planting or fertiliser options for farmers.

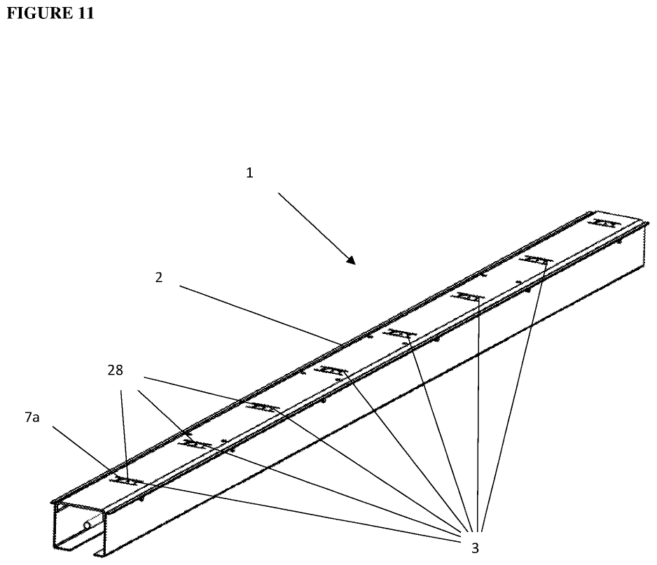

In one example, each spaced apart aperture 3 on the interchangeable cassette 1 is in fluid communication with a metering roller 7a in the interchangeable metering cassette 6 (as shown in FIG. 11). In one example, each metering roller is positioned substantially beneath each aperture such that, in use, seed flows through each aperture into the indentations of each metering roller. In one example, the number of spaced apart apertures on the interchangeable cassette is the same as the number of metering rollers in the interchangeable cassette.

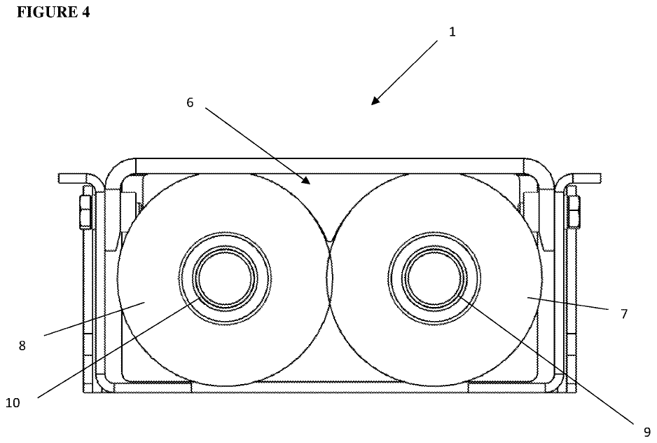

As shown in FIGS. 4 and 6 to 11, the elongate housing 2 houses the interchangeable metering cassette 6 such that, in use, the interchangeable metering cassette 6 is fully or substantially protected from exposure to the external environment. It is to be appreciated that FIGS. 4 and 6 to 11 are sectioned views that show the interior of the interchangeable cassette. In use, the interchangeable metering cassette described herein may include end caps attachable or fixable at each end of the elongate housing such that the elongate housing, and thus the interchangeable cassette, is fully enclosed, when in use. This is advantageous because the fully enclosed elongate housing may prevent seed or fertilizer overflow from the interchangeable metering cassette, when in use. It may also protect the interchangeable metering cassette (for example, the metering rollers) from weather damage (such as wind or rain damage), damage by domestic or feral animals, and may prevent birds from nesting within the interchangeable metering cassette.

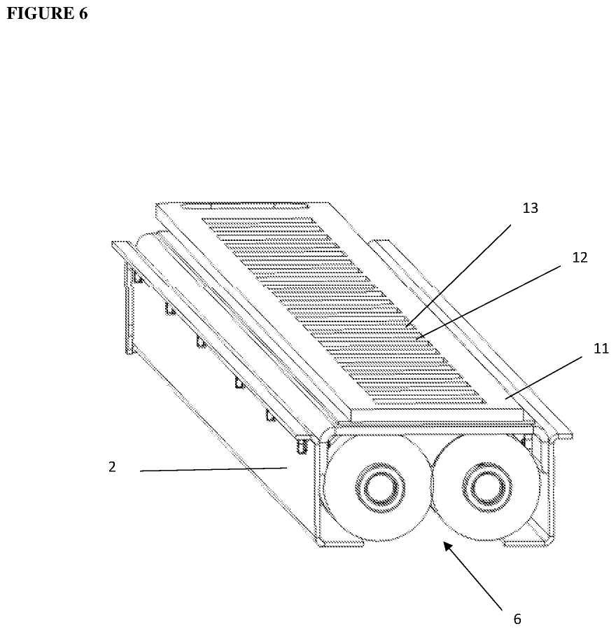

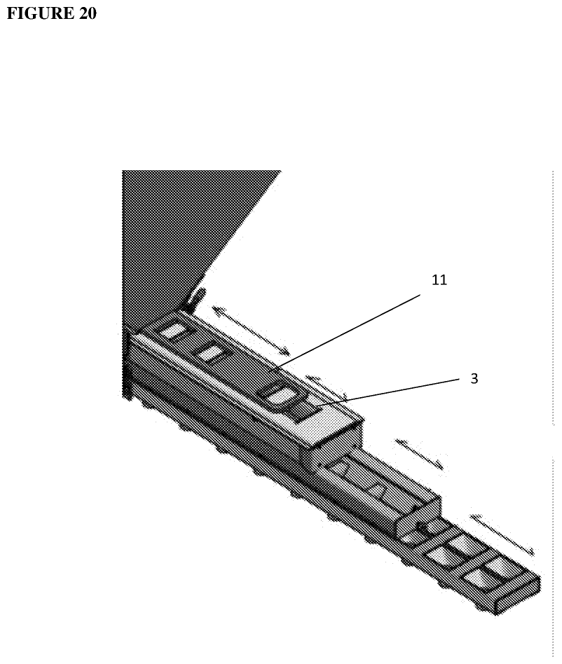

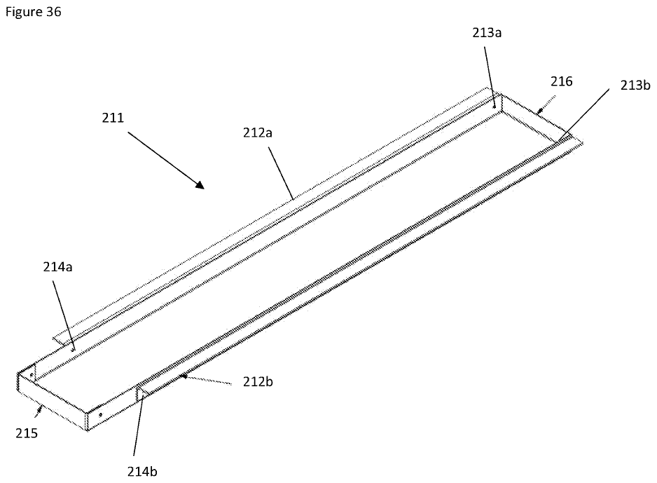

As shown in FIGS. 6 and 8, the elongate housing 2 optionally supports an elongate lock out slide 11 positioned above the plurality of spaced apart apertures 3. In the example shown in FIG. 6, the lock out slide 11 substantially extends the length of the elongate housing 2 of the interchangeable metering cassette and in use, is configured to block or partially block the apertures to control flow rate of seed and/or fertilizer into the interchangeable metering cassette (further shown in FIG. 20). In the example shown in FIG. 6, the elongate lock out slide 11 has a plurality of spaced apart closures 12 and apertures 13 that complement the apertures 3 of the elongate housing 2. In use, the elongate lock out slide 11 may be positioned such that the spaced apart closures partially cover the apertures of the elongate housing to restrict or decrease aperture size. In use, this may control seed and/or fertilizer flow by restricting or limiting the seed size, seed type, and/or fertilizer type able to flow from the hopper 4 through the apertures 3 of the elongate housing 2 and into the interchangeable metering cassette 6. It is to be appreciated that the elongate lock out slide may be positioned to provide a range of aperture sizes on the elongate housing, when in use, and that the user may select and/or adjust aperture size depending on the seed size, seed type and/or fertilizer type to be metered. It is to be appreciated that the lockout slide under the hopper can used in combination with a calibration tray (as shown in FIG. 36) or chute tray, where the opening of the lock out slide under the hopper releases seed or fertilizer into the calibration or chute tray to quick release of left over material in the hopper. The elongate lock out slide can be constructed of any suitable material. In one example, the elongate lock out slide is constructed of one or more industrially robust materials, such as, without limitation, nylon, steel, mild steel, stainless steel, plastic, carbon fibre and the like.

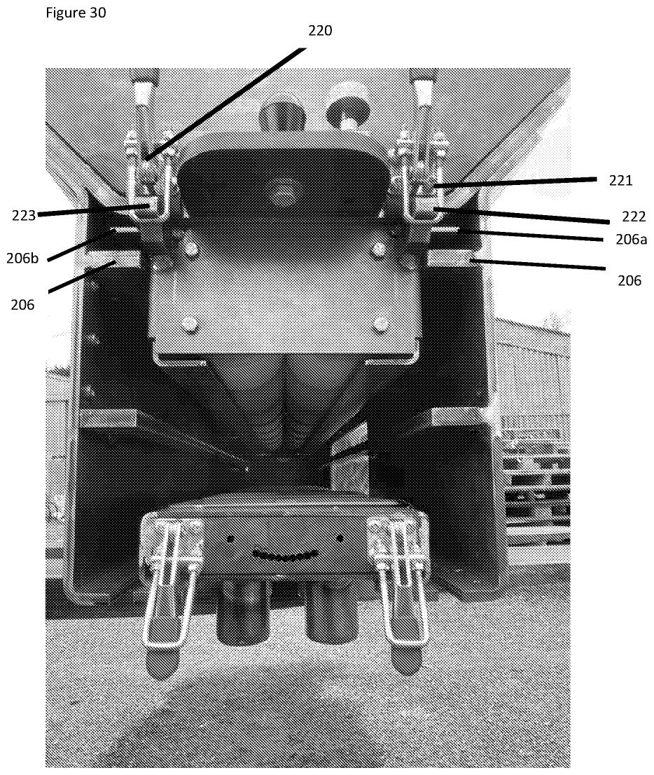

In one example, the elongate lock out slide may be positioned to cover the apertures of the elongate housing to block or prevent seed and/or fertilizer flow from the hopper through the apertures of the elongate housing and into the interchangeable metering cassette, when in use. This may allow a user to clean or interchange, for example, the interchangeable cassette and/or the metering rollers while seed is in the hopper, without needing to remove it. In addition, the lock out slide may prevent seed from overflowing or falling out of the hopper when the interchangeable cassette is removed and/or interchanged as necessary. It is to be appreciated that an elongate lock out slide may also be positioned beneath the interchangeable metering cassette to prevent access to the metering rollers, or to isolate the metering rollers from external elements, such as weather, birds or rodents. Similarly, a lock out slide 100 beneath the metering rollers as illustrated in FIG. 30 prevents any seed within the interchangeable metering cassette dropping out of the cassette at the completion of use.

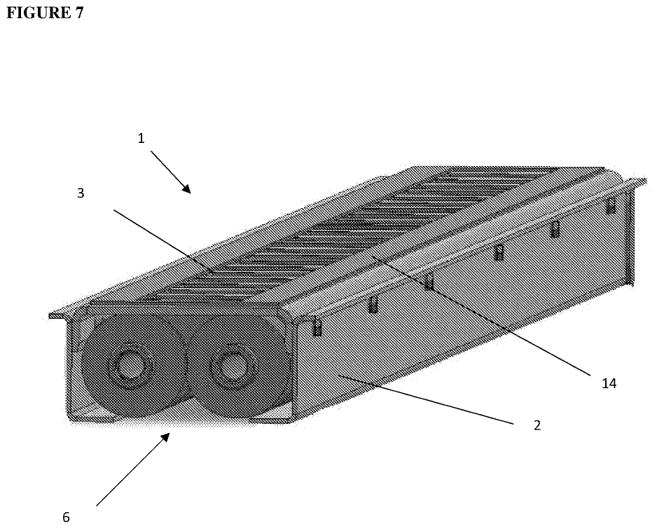

As shown in FIG. 7, the elongate housing 2 optionally further supports a friction-reducing layer 14 positioned between the plurality of spaced apart apertures 3 of the elongate housing 2 and the elongate lock out slide 11, which in use helps facilitate movement of the elongate lock out slide 11. In the example shown in FIG. 7, the friction-reducing layer 14 substantially borders the elongate lock out slide 11 such that it does not overlay or cover the apertures 3, when in use. In one example, the friction-reducing layer may be fabricated from low-friction material or lubricant. Non-limiting examples of low-friction or lubricant material include nylon, mild steel, stainless steel, or any other suitable material.

In one example, a plurality of interchangeable metering cassettes may be provided in a kit (not shown). In one example, the kit may include at least two or more, at least three, at least four, or at least five or more interchangeable cassettes. In one example, each interchangeable cassette within the kit has a plurality of spaced apart apertures with a different predetermined size to accommodate a range of different seed types and/or fertilizer types.

In one example, the kit includes a range of interchangeable cassettes, wherein each interchangeable cassette includes one or more metering rollers with graduated indentation sizes.

In one example a plurality of interchangeable metering cassettes may be provided in a kit with one or more lock out slides. In one example a plurality of interchangeable metering cassettes may be provided in a kit with one or more lock out slides and a calibration tray.

### Interchangeable Dispensing Cassette and Dispensing System

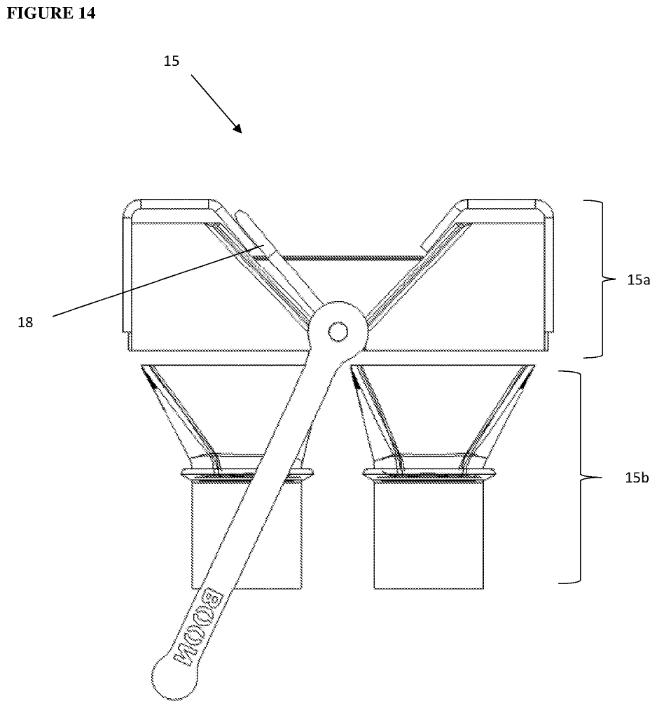

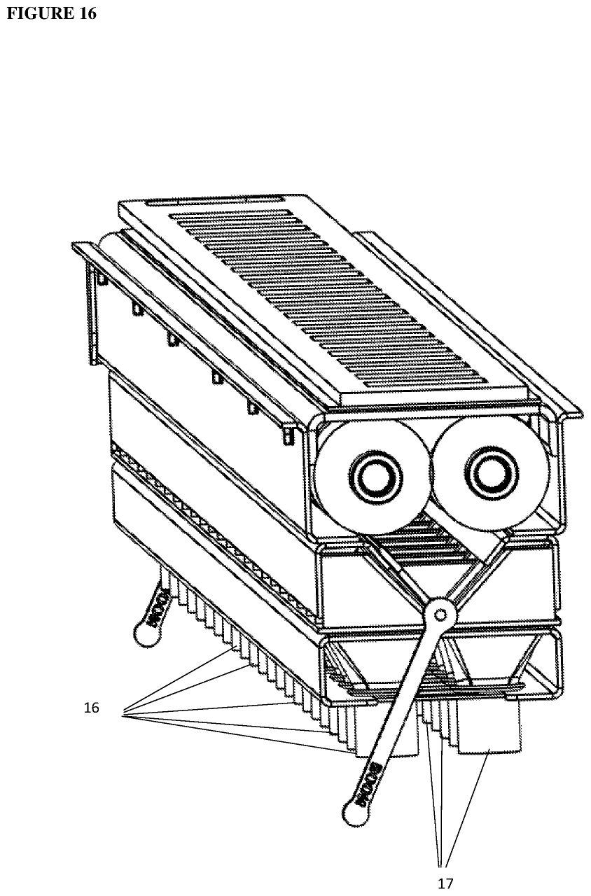

With reference to FIGS. 14 to 16, a dispensing system 15 suitable for use with a hopper is shown. In one example (not shown), the dispensing system includes an interchangeable dispensing cassette 15a comprising a first row of outlets which substantially extend the length of the dispensing cassette and hopper, when in use. In one example, each outlet of the first row narrows prior to seed and/or fertilizer dispersal. In one example, each outlet of the first row of outlets includes a funnel. In one example, the dispensing system 15 includes an interchangeable dispensing cassette 15a and a dispensing unit 15b, which includes a first row of outlets 16 which substantially extend the length of a hopper, when in use, and a second row of outlets 17 which substantially extend the length of the hopper, when in use. In one example, each outlet of the first row 16 and each outlet of the second row 17 narrow prior to seed and/or fertilizer dispersal. In one example, each outlet of the first row 16 and each outlet of the second row 17 include a funnel 16a, 17a. In use, seed and/or fertilizer flow through a bottom opening of the hopper into the dispensing system 15. In one example (not shown), an interchangeable metering cassette proximate the bottom opening of the hopper and the first row of outlets of the interchangeable dispensing cassette is provided. In one example (not shown), an interchangeable metering cassette proximate the bottom opening of the hopper and the first and second row of outlets of the interchangeable dispensing cassette is provided. In use, seed and/or fertilizer flow from the bottom opening of the hopper into the interchangeable metering cassette and into the dispensing system including the interchangeable dispensing cassette. In one example, the interchangeable metering cassette substantially extends the length of the bottom opening of the hopper and a length of the dispensing system. It is to be appreciated that a variety of different interchangeable metering cassettes and interchangeable dispensing cassettes and dispensing units can be used in the example described herein.

In one example (not shown), the interchangeable dispensing cassette may further include a third row of outlets which substantially extend the length of the hopper, when in use. In one example, the interchangeable dispensing cassette may further include a fourth row of outlets which substantially extend the length of the hopper, when in use. It is to be appreciated that the interchangeable dispensing cassette can be configured in a variety of ways to include a varying number of rows of outlets, and the examples described herein are not intended to be limiting on the disclosure.

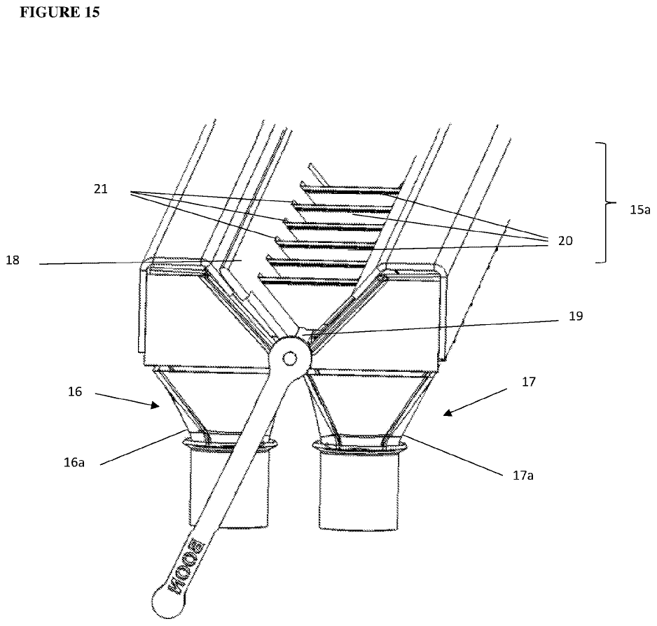

In the example shown in FIGS. 14 to 16, the dispensing system 15 includes within the interchangeable dispensing cassette a moveable paddle 18 configured to, in use, facilitate directional flow and dispersion of seed and/or fertilizer from the hopper through either the first row of first outlets 16 of the interchangeable dispensing cassette, the second row of second outlets 17, of the interchangeable dispensing cassette or both the first row of first outlets 16 and the second row of second outlets 17. In one example, the paddle movement is controllable through an elongate drive shaft 19 that upon rotation rotates the paddle 18 from between the first row of outlets 16 and the second row of outlets 17 within the interchangeable dispensing cassette. In one example, the paddle 18 is configured to shut off access to the first row of outlets 16 or shut off access to the second row of outlets 17 (as shown in FIG. 15). In one example, the paddle may be configured to partially shut off access to the first row of outlets or to partially shut off access to the second row of outlets (not shown). In one example, the paddle may be positioned to facilitate substantially even flow of seed and/or fertilizer between the first row of outlets and the second row of outlets, when in use (not shown). It is to be appreciated that the paddle may be positioned in a plurality of intermediate positions which in use facilitate proportional controllable dispersion of any seed and/or fertilizer through the first row of outlets and the second row of outlets of the interchangeable dispensing cassette. In one example, the paddle movement may be controllable by electronics. In one example, the paddle includes a paddle handle which in use is configured to control and facilitate paddle movement.

In the example shown in FIG. 15, each outlet of the first row 16 and each outlet of the second row 17 within the interchangeable dispensing cassette are separated by a plurality of dividers 20. In one example, the plurality of dividers 20 are spaced apart at regular intervals along the length of the interchangeable dispensing cassette 15a. In one example, the paddle 18 may be configured to pass over the plurality of dividers 20 by having a plurality of spaced apart complimentary slots 21. The plurality of dividers 20 may help facilitate even dispersion of seed and/or fertilizer throughout the first row of outlets 16 and the second row of outlets 17, when in use. Further, the plurality of dividers 20 together with the plurality of spaced apart complimentary slots 21 of the paddle 18 may provide additional strength for movement of the paddle, when in use. It is to be appreciated that the dispensing system may be used in a variety of ways and with a variety of different machines and apparatuses (such as, without limitation, agricultural machines, seed drills, precision drills, gravity seed hoppers systems, and the like). The examples described herein are by way of example only and are not intended to be limiting on the disclosure.

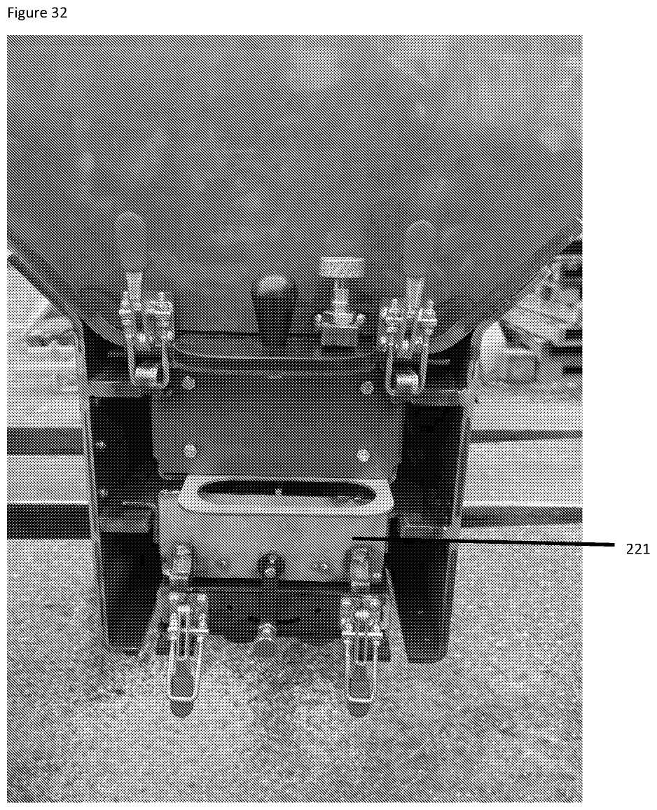

An example of a dispensing cassette 221 is shown in FIG. 32. The dispensing cassette is held in place by tabs that extend from the housing of the dispensing cassette that are then engaged by corresponding quick release cam latches.

In one example, a plurality of interchangeable dispensing cassettes may be provided in a kit (not shown). In one example, the kit may include at least two or more, at least three, at least four, or at least five or more interchangeable cassettes. In one example, each interchangeable cassette within the kit has a plurality of spaced apart apertures with a different predetermined size to accommodate a range of different seed types and/or fertilizer types.

In one example, the kit includes a range of interchangeable dispensing cassettes, and one or more interchangeable metering cassettes described above.

In one example a plurality of interchangeable dispensing and metering cassettes may be provided in a kit with one or more lock out slides. In one example a plurality of interchangeable metering cassettes and one or more interchangeable dispensing cassettes may be provided in a kit with one or more lock out slides and one or more calibration trays.

### Modular Dispensing System

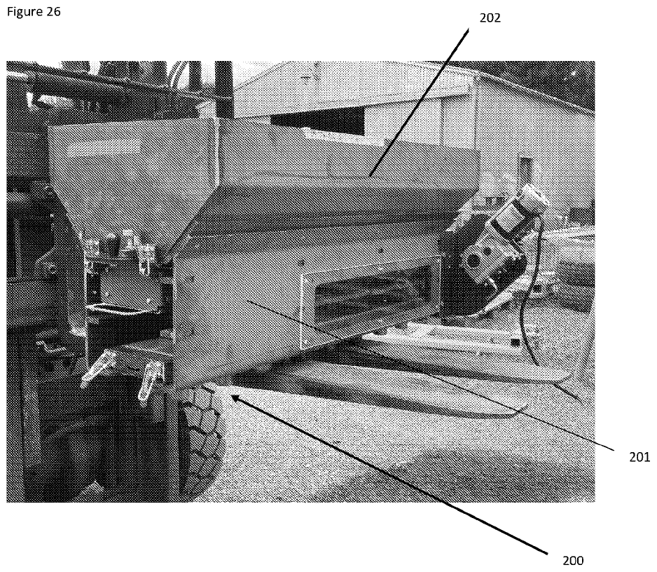

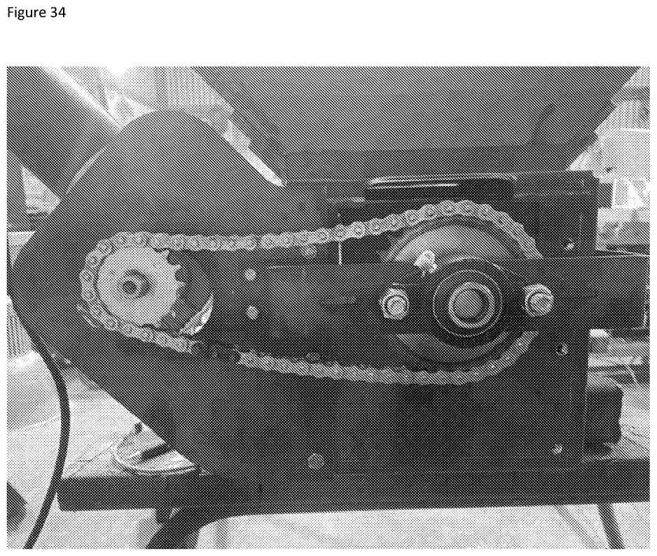

In another aspect, a modular dispensing system is provided. This system is best shown in FIGS. 26 to 34. FIGS. 26 to 34 show a prototype of the modular dispensing system 200, which includes an elongate housing 201 having spaced apart first and second side walls 201a and 201b respectively, the side walls being spaced apart by an elongate top panel 201c that together form the housing of the modular dispensing system (see FIG. 27). The elongate top panel 201c is configured to provide an elongate slot above the housing. The top of each side wall flaring outwardly to complement the profile of the top panel 201c, which is shaped to be engageable with a hopper 202 and any hopper lock out slide 202a along the top panel of the elongate housing. Within the housing there is provided two or more spaced apart elongate channels 203 and 204 (see FIG. 27) to receive from a first end of the housing one or more interchangeable cassettes, at least one or more of the interchangeable cassettes being engageable with a drive unit 205 (see FIG. 28) located on the second end of the elongate housing, the modular dispensing system providing along a bottom side of the elongate housing a further elongate channel to optionally receive from the first end an a further interchangeable cassette, the housing and interchangeable cassettes being in fluid communication from the top side of the elongate housing to the bottom of the dispensing unit. The interchangeable cassettes being in fluid communication with a dispensing unit 209, the dispensing unit connecting, in use with a seed drill, precision drill or other seed or fertilised dispensing means through outlets 210a and/or 210b as desired. It is to be appreciated that the flow through the respective outlets can be controlled through any interchangeable dispensing cassette or the dispensing unit 209.

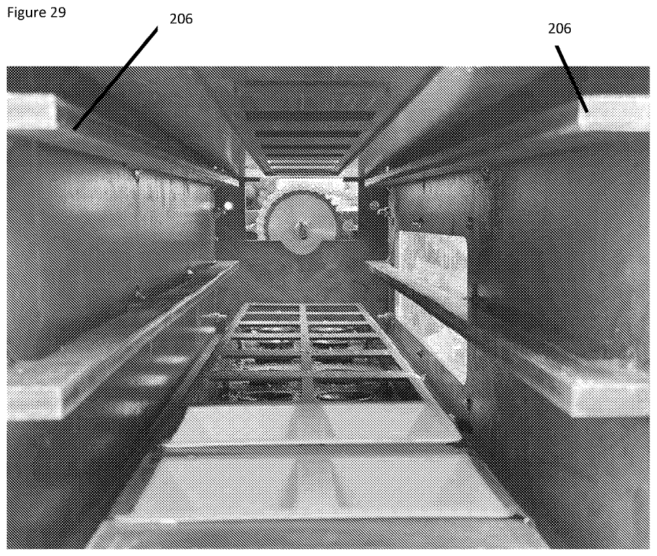

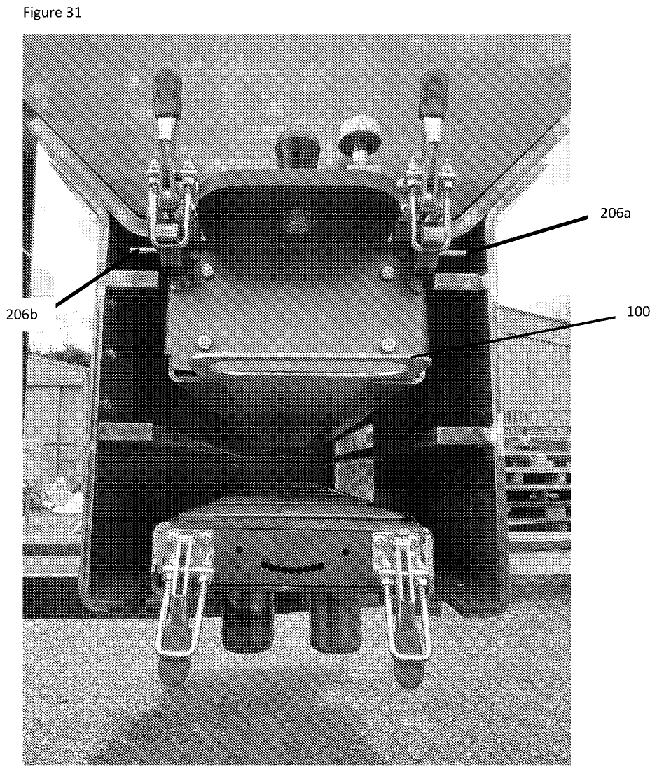

In one example, the modular dispensing system has pairs of ribs 206 and 207 respectively extending partially from the internal side of the side walls of the housing and along the length of the elongate channels the ribs being configured to receive and bear corresponding flanges (206a and 206b) extending from the one or more interchangeable cassettes (not shown in FIG. 28, but shown in FIGS. 30 and 31). In one example as shown in FIG. 29, the ribs at the first end 206 taper by about 1 degree, or 2 degrees, or about 3 degrees or as much as about 4 degrees or about 5 degrees towards the top of the elongate housing towards the second end of the dispensing system. The degree of angle/taper assists making it easier to slide the interchangeable cassette into position. As shown in FIG. 30, the cam locking latches 220 and 221 then are used engage with tabs 22 and 223 respectively to level the interchangeable cassette relative to the ribs 206 and to positively engage a raised profile of the interchangeable cassette into a complimentary recess (201d shown in FIG. 28) in the top panel.

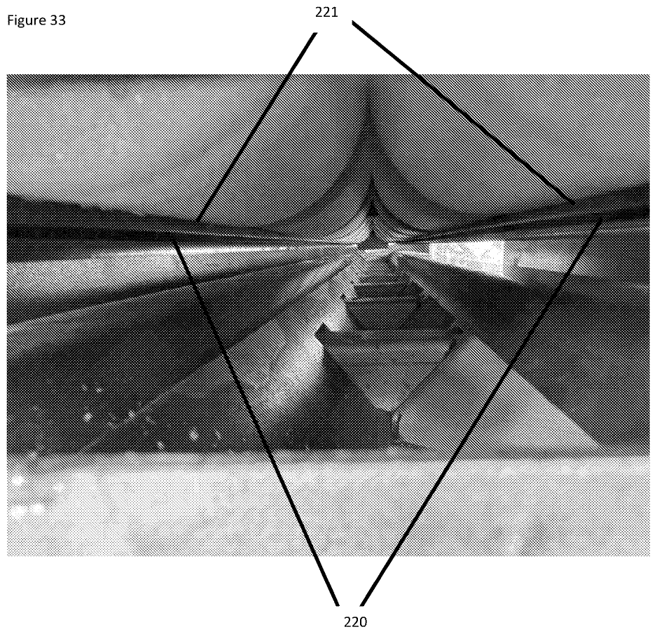

In FIG. 33, a close up view of the underside of a pair of metering rollers in an interchangeable metering cassette is shown. The Figure also shows the channels 220 that a lock out slide will accommodate when locking off the bottom of the interchangeable metering cassette. The upper profile 221 of the lockout channel is configured to also double as a scraper to scrape seed off the metering roller as it rotates.

It is to be appreciated that the housing is designed to provide a significant number of options to mix and match various interchangeable cassettes having differing functionalities. For example, an interchangeable cassette including an agitator as shown in FIG. 24 may be located above an interchangeable metering cassette, which then feeds into a dispensing unit at the bottom of the housing. The agitator may be required, should the seed or fertiliser type be known to aggregate. Similarly, a calibration tray 211, as shown in FIG. 36, the calibration tray having flanges that extend along 212a and 212b respectively to ride along the internal ribs of the housing could be utilised within the modular dispensing system under an interchangeable metering cassette to determine how much seed falls through the metering cassette at a particular rotation rate of the metering rollers within the cassette for a given seed or fertiliser type. This allows a farmer to calibrate the dispensing rate over a set period of time through the interchangeable metering cassette.

In one example the modular dispensing system is positioned above and engaged with an agricultural drilling system.

In one example the agricultural drilling system is a precision drilling system.

### Agricultural Hopper System Including Modular Dispensing System

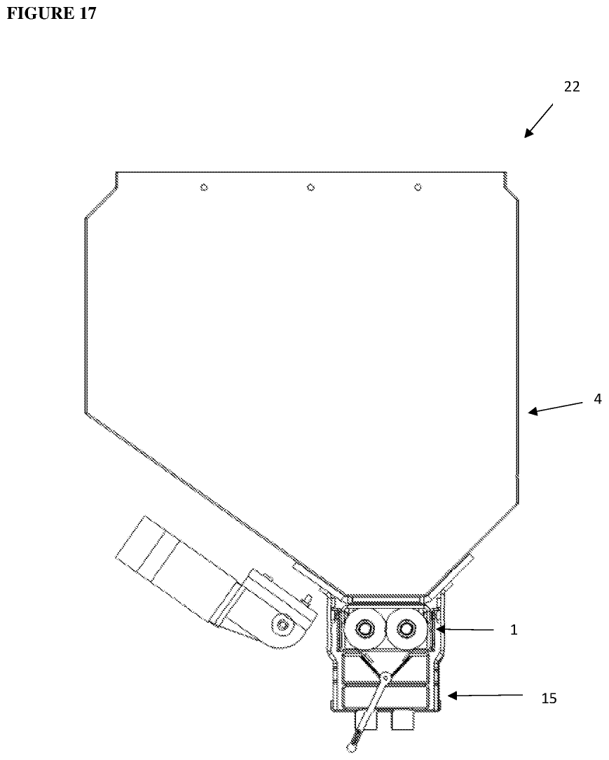

With reference to FIGS. 17 to 20, and FIGS. 26 to 34 and FIG. 37 an agricultural hopper system including a modular dispensing system is provided. In one example, the agricultural hopper system is a gravity seed hopper system 22. The gravity seed hopper system 22 includes a hopper 4, an interchangeable metering cassette 1 as described in any one of the examples above and a dispensing system 15 as described in any one of the examples above. It is to be appreciated that the agricultural hopper system may include any number of hoppers, such as, without limitation, one or more, two or more, three or more, or four or more hoppers. In one example, the number of interchangeable metering cassettes in the agricultural hopper system may correspond to the number of hoppers in the agricultural hopper system. For example, the agricultural hopper system may include a first interchangeable metering cassette that is proximate to and substantially extends the length of a bottom opening of a first hopper, and a second interchangeable cassette that is proximate to and substantially extends the length of a bottom opening of a second hopper. The agricultural hopper system having at least two hoppers and at least two interchangeable metering cassettes allow a user to compartmentalise the agricultural hopper system by blocking seed flow from the first and/or second hopper through the first and/or second interchangeable cassette, respectively. This is advantageous because it allows for selective and controlled planting (such as precision planting) of different seed types within a single run, and without needing to refill the hopper.

The hopper 4 is configured to house any seed and/or fertilizer. In the example shown in FIGS. 17 to 19, the hopper 4 includes a storage body 23 including sidewalls 24, and a top opening 25 and a bottom opening 5. In the example shown, the hopper 4 is adapted and configured to include a funnel shape such that in use, seed and/or fertilizer may funnel out the bottom opening 5 of the hopper 4. It is to be appreciated that the hopper can be adapted and configured in a variety of shapes and sizes, and that the shape and size may depend on the seed type and/or fertilizer type to be metered. In use, the hopper may be filled or partially filled with seed and/or fertilizer. Non-limiting examples of seed type include seed such as wheat, barley, rye, rapeseed, oats, peas, soybeans, alfalfa, hemp, swede, maize, fodder beet and the like. In one example, the fertilizer is liquid or organic fertilizer. Non-limiting examples of liquid fertilizer include potassium chloride liquid fertilizer, potassium nitrate liquid fertilizer, potassium magnesium sulfate liquid fertilizer, potassium sulfate liquid fertilizer, urea liquid fertilizer, calcium ammonium nitrate liquid fertilizer, and the like. Non-limiting types of organic fertilizer include manure, slurry fertilizer, worm castings, peat, seaweed fertilizer, guano, compost, bloodmeal, bone meal and the like. In one example, the hopper is filled with a single seed type. In one example, the hopper is filled with a single fertilizer type. In one example, the hopper may be filled with multiple different seed types of varying shapes and sizes. For example, two or more, three or more, four or more, or five or more different seed types. In one example, the hopper may be filled with multiple different fertilizer types. In one example, the hopper may be filled with seed and fertilizer. In one example, the hopper may include a removeable lid that is configured and adapted to substantially cover the top opening of the hopper (not shown). In use, the lid may prevent seed and/or fertilizer overflow. In the example shown, the gravity seed hopper system 22 includes a single hopper. In one example (not shown), the gravity seed hopper system may include a plurality of hoppers, such as, without limitation, at least two, at least three, at least four, at least five hoppers. The hopper can be constructed of any suitable material. In one example, the hopper is constructed of one or more industrially robust materials, such as, without limitation, any suitable plastics material, steel, mild steel, stainless steel, and the like.

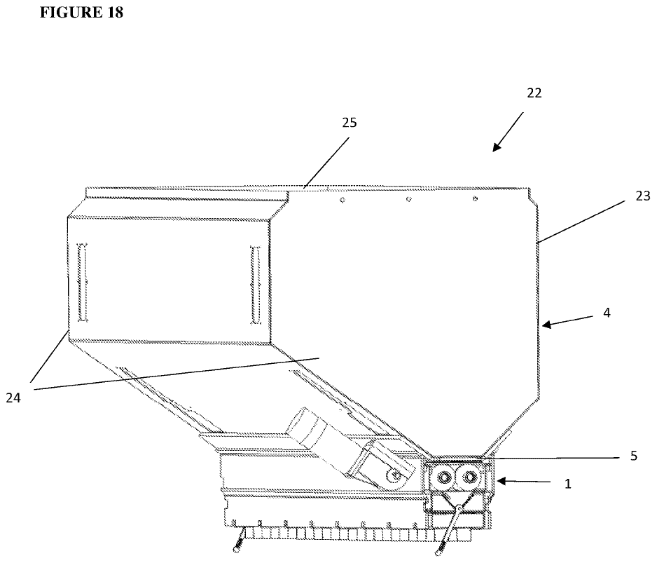

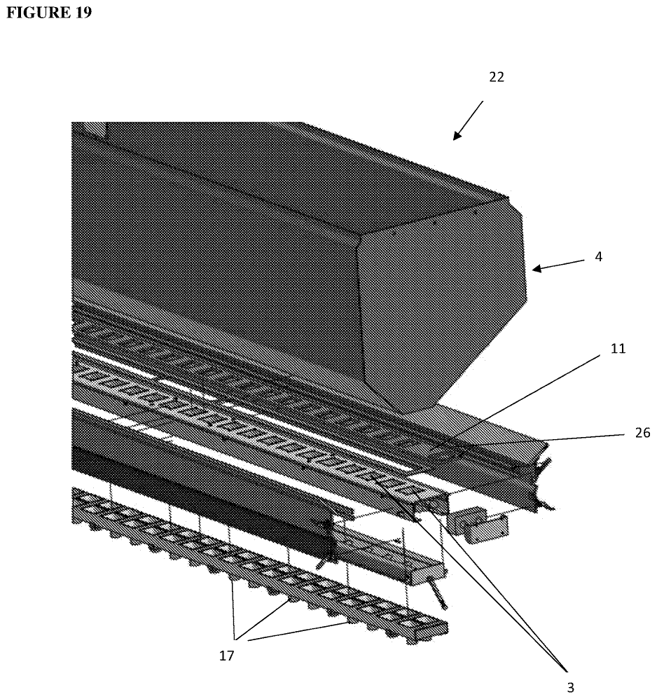

In the example shown in FIGS. 18 to 19, the interchangeable metering cassette 1 is proximate to and substantially extends the length of the bottom opening 5 of the hopper 4. In use, seed and/or fertilizer flow from the bottom opening 5 of the hopper 4 and through the plurality of spaced apart apertures 3 and into the interchangeable metering cassette 6 of the interchangeable cassette 1. The plurality of spaced apart apertures 3 may control seed and/or fertilizer flow from the hopper 4 into the interchangeable metering cassette 6 of the interchangeable cassette 1. For example, seed and/or fertilizer flow from the bottom opening of the hopper into the interchangeable metering cassette of the interchangeable cassette may be limited by aperture shape, aperture size and/or aperture spacing. This is advantageous because seed and/or fertilizer flow can be adjusted and controlled by adjusting or changing aperture size without needing to interchange the hopper or other components of the gravity seed hopper system, when in use.

In the example shown in FIGS. 18 to 19, the gravity seed hopper system 22 further includes a pair of complimentary cavities 26 proximate the bottom opening 5 of the hopper 4 and above the plurality of spaced apart apertures 3 on the elongate housing 2 of the interchangeable cassette 1. In use, the pair of complimentary cavities 26 are configured to receive the elongate lock out slide 11. In one example, the positioning and movement of the elongate lock out slide is controllable by electronics. In one example, the elongate lock out slide is controllable manually.

In the example shown in FIGS. 17 to 19, the dispensing system 15 is proximate a bottom 27 of the interchangeable cassette 1, such that in use, seed and/or fertilizer flow from the interchangeable metering cassette 6 of the interchangeable cassette 1 into the dispensing system 15. In one example, the dispensing system includes a first row of outlets which substantially extend the length of the interchangeable cassette, when in use. In the example shown in FIGS. 17 to 19, the dispensing system includes a first row of outlets 16 which substantially extend the length of the interchangeable cassette 1, and a second row of outlets 17 which substantially extend the length of the interchangeable cassette 1, when in use. It is to be appreciated that the outlets can be configured and adapted in a variety of shapes and sizes and that the example illustrated is just one possible configuration and is not intended to be limiting on the disclosure.

In the example shown in FIGS. 17 to 19, the gravity seed hopper system 22 includes a moveable paddle 18 as described in any one of the examples above. The moveable paddle 18 is configured to, in use, facilitate directional flow and dispersion of seed from the hopper 4 through either the first row of first outlets 16, the second row of second outlets 17, or both the first row of first outlets 16 and the second row of second outlets 17.

In one example, a first row of outlet tubes may be attachable to the first row of outlets, when in use. In one example, a first row of outlets may be attachable to the first row of outlets and a second row of outlet tubes may be attachable to the second row of outlets, when in use (not shown). In one example, the first and/or second row of outlet tubes may be adapted and configured to facilitate planting of seed to be dispersed into a ground or surface, when in use. In one example, the first and/or second row of outlet tubes may be adapted and configured to facilitate seed and/or fertilizer dispersal on top of the ground or surface, when in use. In one example, the first row of outlet tubes may be adapted and configured to facilitate planting of seed into a ground or surface, when in use, and the second row of outlet tubes may be adapted and configured to facilitate seed and/or fertilizer dispersal on top of the ground or surface, when in use.

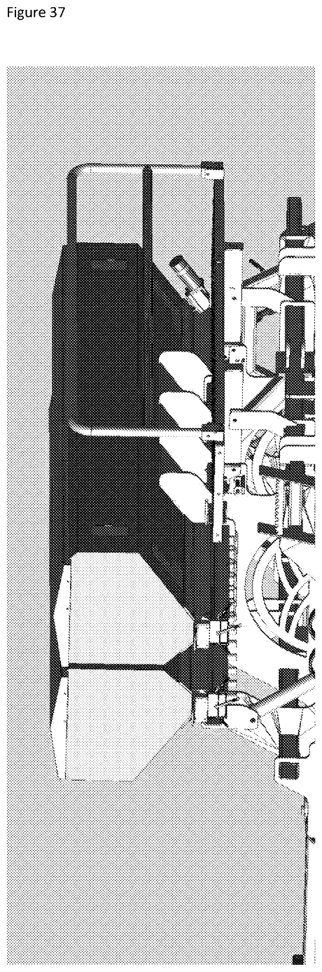

It is also to be appreciated that more than one agricultural hopper system including a modular dispensing system may be employed and a very schematic system is shown in FIG. 37, where a dual agricultural hopper system is depicted, each hopper having a modular dispensing system located underneath.

### Advantages

The modular dispensing system provides many options to use a number of metering cassettes in a number of configurations for different seed types, different sowing conditions and the like. The system also allows other advantages such as easy dumping of left over seed from the hopper at the end of sowing. It is important to remove all seed from the hopper to ensure there is no cross contamination between crops. The modular system enables a calibration tray that also acts as a seed or fertiliser chute to be used. For example, a lock out slide is used to close off the seed from a hopper into the interchangeable metering cassette. The interchangeable metering cassette is then removed along with any lower cassette (eg second interchangeable metering cassette or dispensing cassette) and a calibration tray, as shown in FIG. 36, having angle iron along each side with one end being bolted to allow rotation of the calibration tray around pivot points 213a and 213b and the other end being secured by spring latches at points 214 a and 214b, which may be released to release one end of the calibration tray to thereby lower the end 215 of the tray relative to the other end of the tray 216. With the release of the spring latches at end 215 of the calibration tray, the tray effectively becomes a chute as the tray rotates around the bolted pivot at the other end to allow the released end of the tray to lower and upon opening the lock out slide the unused seed in the hopper drops into the chute and slides down the chute/calibration tray into a bag or seed collection device to prevent the loss of seed and the indiscriminate dropping of the seed from the hopper. This allows for the quick cleaning of the hopper and change over to another seed type, with perhaps the changeover of an interchangeable metering cassette to allow a farmer to sow another seed type in a very quick time frame.

The modular dispensing unit allows a farmer to purchase a single seed sowing system that can accommodate a wide variety of seed types and sow them in a number of ways using one system that offers different sowing rates, different seed coverage options, precision planting options and the like.

Another advantage with the modular dispensing system is that air flow and moisture levels can be controlled by fitting a small fan system within the housing of the modular dispensing system that may be used when the system is both in use and not in use to keep the cassettes dry and mostly free of moisture.

The foregoing description is by way of example only, and may be varied considerably without departing from the scope of the present disclosure. Persons of ordinary skill can utilize the disclosures and teaching herein to produce other embodiments and variations without undue experimentation. All such embodiments and variations are considered to be part of this invention.

The foregoing descriptions and drawings should be considered as illustrative only of the principles of the interchangeable cassette, the dispensing system and the agricultural hopper system comprising the same, described. The interchangeable cassette, the dispensing system and the agricultural hopper system may be configured in a variety of shapes and sizes and are not limited by the dimensions of the embodiments shown. Numerous applications of the present disclosure will readily occur to those skilled in the art. Therefore, it is not desired to limit the interchangeable cassette, the dispensing system and the agricultural hopper system comprising the same to the specific examples disclosed or the exact construction and operation shown and described. Rather, all suitable modifications and equivalents may be resorted to, falling within the scope of the invention.

In this specification, where reference has been made to external sources of information, including patent specifications and other documents, this is generally for the purpose of providing a context for discussing the features of the present invention. Unless stated otherwise, reference to such sources of information is not to be construed, in any jurisdiction, as an admission that such sources of information are prior art or form part of the common general knowledge in the art.

1. A modular dispensing system including an elongate housing, the elongate housing having spaced apart first and second elongate side walls, the side walls being spaced apart by an elongate top panel, the top panel of the housing being configured to be engageable with a hopper, the top panel being configured to allow the flow of matter within the hopper into the housing, when in use; the housing providing two or more spaced apart elongate channels that extend the length of the housing and that are configured to receive from a first end of the housing one or more interchangeable cassettes, at least one or more of the interchangeable cassettes being engageable with a drive unit located on the second end of the elongate housing, the modular dispensing system having a dispensing unit located at the bottom of the housing, the housing and one or more interchangeable cassettes being in fluid communication from the top panel of the elongate housing to the dispensing unit.

2. The modular dispensing system as claimed in claim 1, wherein the housing provides one or more pairs of ribs, one rib of each pair extending partially from an internal side wall of the housing facing the other rib extending partially from the opposing internal side wall, each rib extending along the length of the elongate channels, the ribs being configured to receive and bear corresponding flanges extending from the one or more interchangeable cassettes.

3. The modular dispensing system as claimed in claim 2, wherein the one or more pairs of ribs taper upwardly towards the top panel of the housing at an angle selected from:
a. up to about 5 degrees from the first end of the housing to the second end of the housing;
b. up to about 4 degrees from the first end of the housing to the second end of the housing;
c. up to about 3 degrees from the first end of the housing to the second end of the housing;
d. up to about 2 degrees from the first end of the housing to the second end of the housing; and
e. up to about 1 degree from the first end of the housing to the second end of the housing.

4. The modular dispensing system as claimed in any one of claims 1 to 3 wherein a top portion of each side panel flares outwardly to complement the profile of the top panel of the housing, the top panel, being configured to engage with a hopper positioned and nested thereon, when in use.

5. The modular dispensing system as claimed in any one of claims 1 to 4, wherein the one or more interchangeable cassettes is an interchangeable metering cassette.

6. The modular dispensing system as claimed in any one of claims 1 to 4 wherein the one or more interchangeable cassettes is an interchangeable dispensing cassette.

7. The modular dispensing system as claimed in any one of claims 1 to 4 the one or more interchangeable cassettes is an interchangeable metering cassette and an interchangeable dispensing cassette.

8. The modular dispensing system as claimed in any one of claims 1 to 7 is configured and adapted to be engaged with an agricultural seed drilling system.

9. The modular dispensing system as claimed in claim 8, wherein the agricultural drilling system is a precision drilling system.

10. The modular dispensing system as claimed in claim 8, wherein the agricultural drilling system is a gravity seed drill system.

11. An interchangeable metering cassette for use in a modular dispensing system as claimed in any one of claims 1 to 10, wherein the interchangeable cassette comprises:
an elongate housing providing a plurality of spaced apart apertures configured to receive seed and/or fertilizer from a hopper, when in use;
wherein the elongate housing houses a metering system located beneath the apertures, the metering system comprising one or more metering rollers;
wherein the one or more metering rollers are each mounted on an axle, wherein each axle substantially extends the length of the elongate housing;
wherein, in use, at least one axle is engageable with the drive unit on the modular dispensing system so as to rotate the one or more metering rollers, the rotation of the one or more metering rollers facilitating the controllable flow of seed and/or fertilizer through the metering system.

12. The interchangeable metering cassette of claim 11, wherein the metering system comprises:
a pair of metering rollers that extend substantially the length of the elongate housing,
wherein one face of a first metering roller is in surface contact with a second face of a second metering roller.

13. The interchangeable metering cassette of any claim 11 or claim 12 wherein the metering system comprises:
a plurality of paired metering rollers that together substantially extend the length of the elongate housing,
wherein one face of a first metering roller of each pair is in surface contact with a second face of a second metering roller of the pair.

14. The interchangeable metering cassette of any one of claims 11 to 13, wherein each metering roller comprises an outer casing fabricated from a soft and resilient material.

15. The interchangeable cassette of claim 14, wherein each metering roller comprises an outer casing fabricated from sponge foam.

16. The interchangeable metering cassette of claim 11, wherein the one or more metering rollers comprises:
a plurality of spaced apart indentations,
wherein each indentation is adapted and configured in shape and size to receive seed, when in use.

17. The interchangeable metering cassette of claim 11 or claim 16, wherein the metering system comprises:
a plurality of spaced apart metering rollers extending substantially the length of the elongate housing, and
wherein each metering roller comprises a plurality of spaced apart indentations, wherein each indentation is configured and adapted in shape and size to receive seed, when in use.

18. The interchangeable metering cassette of claim 16 or 17, wherein each indentation is configured and adapted in shape and size to receive a single seed, when in use.

19. The interchangeable metering cassette of any one of claims 16 to 18, wherein the indentations are a predetermined size, selected for a specific seed type.

20. The interchangeable cassette of any one of claims 16 to 19, wherein each spaced apart aperture on the interchangeable cassette is in fluid communication with a metering roller in the metering system, and
wherein each metering roller is positioned substantially beneath each aperture such that, in use, seed flows through each aperture into the indentations of each metering roller.

21. The interchangeable metering cassette of any one of claims 11 to 20, wherein the rate of rotation of the driving unit is adjustable, when in use.

22. The interchangeable metering cassette of claim 21, wherein the adjustable rate of rotation of the driving means is controllable by electronics.

23. The interchangeable metering cassette of any one of claims 11 to 22, wherein the speed of rotation of the rollers is substantially proportional to the flow rate of the seed and/or fertilizer through the metering system, when in use.

24. The interchangeable metering cassette of any one of claims 11 to 23, wherein the elongate housing houses the metering system such that, in use, the metering system is substantially or fully enclosed.

25. The interchangeable metering cassette of any one of claims 11 to 24, wherein the one or more metering rollers are replaceable.

26. The interchangeable metering cassette of any one of claims 11 to 25, wherein the spaced apart apertures are a predetermined size, selected for the seed and/or fertiliser type.

27. The interchangeable cassette of any one of claims 11 to 26, wherein the elongate housing optionally supports an elongate lock out slide positioned above the plurality of spaced apart apertures, wherein the lock out slide is configured to block or partially block the apertures to control flow rate of seed and/or fertilizer into the metering system, when in use.

28. The interchangeable metering cassette of claim 27, wherein the elongate lock out slide comprises a plurality of spaced apart closures and apertures that complement the apertures of the elongate housing.

29. The interchangeable metering cassette of claim 28, wherein the elongate lock out slide is positioned to provide a range of aperture sizes on the interchangeable cassette which controls seed and/or fertilizer flow from a hopper into the interchangeable cassette, when in use.

30. The interchangeable metering cassette of claim 29, wherein the aperture size of the elongate housing is selected depending on the seed size, when in use.

31. An interchangeable dispensing cassette for use in a modular dispensing system as claimed in any one of claims 1 to 10 comprising:
an elongate housing having
a first row of first outlets which extend substantially the length the cassette, and
a second row of second outlets adjacent the first row which extend substantially the length the cassette,
a moveable paddle configured to, in use, facilitate directional flow and dispersion of seed and/or fertilizer through either:
(a) the first row of first outlets, or
(b) the second row of second outlets, or
(c) both the first row of first outlets and the second row of second outlets.

32. The dispensing cassette of claim 31, wherein the paddle is controllable through an elongate drive shaft that upon rotation rotates the paddle from between the first row of outlets to the second row of outlets, and
wherein the paddle is configured to shut off access to the first row of outlets or shut off access to the second row of outlets.

33. The dispensing cassette of claim 31 or 32, wherein the paddle may be positioned in a plurality of intermediate positions which, in use, facilitates proportional controllable dispersion of any seed and/or fertilizer through the first row of outlets and the second row of outlets.

34. The dispensing cassette of any one of claims 31 to 33, wherein the paddle movement is controllable by electronics.

35. The dispensing cassette of any one of claims 31 to 34, wherein each outlet of the first row and each outlet of the second row are separated by a plurality of dividers, wherein the dividers are spaced apart at regular intervals substantially along the length of the dispensing system.

36. The dispensing cassette of claim 35, wherein the paddle is configured to pass over the dividers by having a plurality of spaced apart complimentary slots.

37. The dispensing cassette of any one of claims 31 to 36, wherein each outlet of the first and second row of outlets is configured to narrow prior to seed and/or fertilizer dispersal, when in use.

38. A kit comprising:
a modular dispensing system as claimed in any one of claims 1 to 11, and
one or more interchangeable cassettes as defined in any one of claims 11 to 30.

39. The kit as claimed in claim 38, wherein the kit further comprises:
one or more interchangeable dispensing cassettes as defined in any one of claims 31 to 37.

40. The kit as claimed in claim 38 or claim 39, wherein the kit further comprises one or more hoppers.
